(19) United States
(12) Patent Application Publication
(10) Pub. No.: US 2016/0072592 A1
(43) Pub. Date: Mar. 10, 2016

(54) Methods and Systems for Multi-Model Block Least Squares/Radial Basis Function Neural Network Based Non-Linear Interference Management for Multi-Technology Communication Devices

(71) Applicant: QUALCOMM Incorporated, San Diego, CA (US)

(72) Inventors: Sheng-Yuan TU, San Diego, CA (US); Farrokh ABRISHAMKAR, San Diego, CA (US); Brian Clarke BANISTER, San Diego, CA (US)

(21) Appl. No.: 14/849,580

(22) Filed: Sep. 9, 2015

Related U.S. Application Data
(60) Provisional application No. 62/048,519, filed on Sep. 10, 2014.
(60) Provisional application No. 62/106,759, filed on Jan. 23, 2015.
(60) Provisional application No. 62/106,755, filed on Jan. 23, 2015.
(60) Provisional application No. 62/106,751, filed on Jan. 23, 2015.
(60) Provisional application No. 62/106,756, filed on Jan. 23, 2015.

(51) Int. Cl. H04B 15/00; H04L 25/02

(52) U.S. Cl. CPC H04B 15/00; H04L 25/0254

(57) ABSTRACT

The various embodiments include methods and apparatuses for canceling nonlinear interference during concurrent communication of multi-technology wireless communication devices. Nonlinear interference may be estimated using a mixed-model block least squares/radial basis function neural network by generating aggressor kernels from the aggressor signals, augmenting the aggressor kernels by weight factors and executing a linear combination of the augmented output, at an intermediate layer to produce intermediate layer outputs. At an output layer, a linear filter function may be executed on the intermediate layer outputs to produce an estimated nonlinear interference used to cancel the nonlinear interference of a victim signal.

### RELATED APPLICATIONS

This application claims the benefit of priority under 35 U.S.C. §119(e) of U.S. Provisional Application No. 62/048,519 entitled “Multilayer Perceptron For Dual SIM Dual Active Interference Cancellation” filed Sep. 10, 2014, U.S. Provisional Application No. 62/106,759 entitled “Block Least Squares Interference Filter for Dual SIM Dual Active Interference Cancellation” filed Jan. 23, 2015, U.S. Provisional Application No. 62/106,755 entitled “Multi-Model Radial Basis Function Neural Network for Dual SIM Dual Active Interference Cancellation” filed Jan. 23, 2015, U.S. Provisional Application No. 62/106,751 entitled “Radial Basis Function Neural Network for Dual SIM Dual Active Interference Cancellation” filed Jan. 23, 2015, U.S. Provisional Application No. 62/106,756 entitled “Banked Radial Basis Function Neural Network for Dual SIM Dual Active Interference Cancellation” filed Jan. 23, 2015, the entire contents of all of which are hereby incorporated by reference.

### BACKGROUND

Some wireless communication devices—such as smart phones, tablet computers, laptop computers, and routers—contain hardware and/or software elements that provide access to multiple wireless communication networks simultaneously. For example, a wireless communication device can have one or more radio frequency communication circuits (or “RF chains”) for accessing one or more wireless local area networks (“WLANs”), wireless wide area networks (“WWANs”), and/or global positioning systems (“GPS”). When multiple reception (“Rx”) and/or transmission (“Tx”) operations are implemented simultaneously, i.e., co-exist, on a wireless communication device, these operations may interfere with each other.

### SUMMARY

The methods and apparatuses of various embodiments provide circuits and methods for managing interference in a multi-technology communication device. Embodiment methods may include receiving, an aggressor signal at an input layer of a multi-model neural network and generating a set of block least squares (BLS) kernels and a set of radial basis function (RBF) kernels. A nonlinear radial basis function may be executed on the set of RBF aggressor kernels at a hidden layer to produce multiple hidden layer outputs. The hidden layer outputs and the BLS kernels may be augmented with weight factors at an intermediate layer of the multi-model neural network. The augmented hidden layer outputs and BLS kernels may be linearly combined at the intermediate layer to produce real intermediate layer outputs and imaginary intermediate layer outputs. A linear filter function may be executed on the real intermediate layer outputs and the imaginary intermediate layer outputs at an output layer of the multi-model neural network to obtain estimated nonlinear interference.

Some embodiments may include determining an error of the estimated nonlinear interference, determining whether the error of the estimated nonlinear interference exceeds an efficiency threshold, and canceling the estimated nonlinear interference from a victim signal. Such embodiments may further include training the weight factors to reduce an error of the estimated nonlinear interference, which may include training weight factors in response to determining that the error of the estimated nonlinear interference exceeds the efficiency threshold. In such embodiments, canceling the estimated nonlinear interference from the victim signal may include canceling the estimated nonlinear interference from the victim signal in response to determining that the error of the estimated nonlinear interference does not exceed the efficiency threshold. In some embodiments training the weight factors may include using a least squares method

Some embodiments may include estimating an initial value of the weight factors using the combined aggressor kernel matrix.

In some embodiments, the linear filter function may be a finite impulse response filter. In some embodiments, the linear filter function may have a Hammerstein structure.

In some embodiments, the received aggressor signal represents an aggressor signal received by an antenna of the multi-technology communication device at a specific instance in time.

In some embodiments, generating a set of BLS kernels and a set of RBF kernels may include executing a kernel function of a pre-determined order on the aggressor signal to obtain BLS kernels, separating the BLS kernels into real value components and imaginary value components, executing a second kernel function of pre-determined order on the aggressor signal to obtain RBF kernels, and separating the RBF kernels into real value components and imaginary value components. Such embodiments may further include continuing the operation of executing the first kernel function of pre-determined order from order 1 to order “p”, inserting the real value components of the BLS kernel associated with each pre-determined order from 1 to p to a BLS kernel matrix, inserting the imaginary value components of the BLS kernel associated with each pre-determined order from 1 to p to an imaginary BLS kernel matrix, and inserting the real BLS kernel matrix and the imaginary BLS kernel matrix into a combined aggressor kernel matrix.

Some embodiments may include canceling the estimated nonlinear interference from a victim signal received by an antenna. Such embodiments may further include decoding the victim signal after canceling the estimated nonlinear interference from the victim signal.

Some embodiments may include training a second set of weight factors associated with the linear filter function using a matrix including the real intermediate layer output and imaginary intermediate layer output. In such embodiments, the second set of weights may be trained using a least squares method.

Some embodiments may include generating a combined aggressor kernel matrix. In such embodiments, the combined aggressor matrix may include the set of BLS kernels and hidden layer outputs. Alternatively, in such embodiments, the combined aggressor kernel matrix may include real and imaginary components of the BLS kernels. Alternatively, in such embodiments, the weight factors are calculated using the combined aggressor kernel matrix.

In some embodiments, the estimated nonlinear interference may include an RBF estimated interference and a BLS estimated interference. Such embodiments may further include augmenting the RBF estimated interference and the BLS estimated interference with a third set of weight factors at an output layer of the multi-model neural network, linearly combining the augmented RBF estimated interference and BLS estimated interference at output layer to produce an estimated non-linear interference.

Embodiments include a multi-technology communication device having an antenna configured to receive an aggressor signal at the multi-technology communication device, and a processor communicatively connected to the antenna and configured with processor-executable instructions to perform operations of one or more of the embodiment methods described above.

Embodiments include a multi-technology communication device having means for performing functions of one or more of the embodiment methods described above.

Embodiments include a non-transitory processor-readable medium having stored thereon processor-executable software instructions to cause a processor to perform operations of one or more of the embodiment methods described above.

### BRIEF DESCRIPTION OF THE DRAWINGS

The accompanying drawings, which are incorporated herein and constitute part of this specification, illustrate exemplary embodiments of the claims, and together with the general description given above and the detailed description given, serve to explain the features of the claims.

FIG. 1 is a communication system block diagram illustrating a network suitable for use with various embodiments.

FIG. 2 is a component block diagram illustrating various embodiments of a multi-technology wireless communications device.

FIG. 3 is a component block diagram illustrating an interaction between components of different transmit/receive chains in various embodiments of a multi-technology wireless communications device.

FIG. 4 is a component block diagram illustrating a block least squares/radial basis function neural network for interference cancellation in accordance with various embodiments.

FIGS. 5A-5B are component block diagrams illustrating layers of a block least squares/radial basis function neural network for interference cancellation in accordance with various embodiments.

FIGS. 6A-D are functional block diagrams illustrating interaction between components of a block least squares/radial basis function neural network for interference cancellation in accordance with various embodiments.

FIG. 7 is a process flow diagram illustrating a method for canceling nonlinear interference using a block least squares/radial basis function neural network in various embodiments of a multi-technology wireless communications device in accordance with various embodiments.

FIG. 8 is a process flow diagram illustrating a method for estimating nonlinear interference using a block least squares/radial basis function neural network in a multi-technology wireless communications device in accordance with various embodiments.

FIG. 9 is a process flow diagram illustrating a method for training weight factors for use in a block least squares/radial basis function neural network in a multi-technology wireless communications device in accordance with various embodiments.

FIG. 10 is a component diagram of an example multi-technology wireless communication device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims or the claims.

The word “exemplary” is used herein to mean “serving as an example, instance, or illustration.” Any implementation described herein as “exemplary” is not necessarily to be construed as preferred or advantageous over other implementations.

The terms “computing device,” “mobile device,” and “wireless communication device” are used interchangeably herein to refer to any one or all of cellular telephones, smartphones, personal or mobile multi-media players, personal data assistants (PDAs), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor and wireless communication circuitry. As used herein, the terms “multi-technology communication device” and “multi-technology communication device” refer to a wireless communication device that supports access to at least two mobile communication networks. While the various embodiments are particularly useful for mobile devices, such as smartphones, the embodiments are generally useful in any electronic device that implements radio hardware in close proximity to other hardware.

Descriptions of the various embodiments refer to multi-technology communication devices for exemplary purposes. However, the embodiments may be suitable for any multiple-technology (multi-technology) wireless communication device that may individually maintain a plurality of connections to a plurality of mobile networks through one or more radio communication circuits. For example, the various embodiments may be implemented in multi-SIM multi-active devices of any combination of number of subscriber identity modules (SIM) and concurrently active subscriptions. Moreover, a SIM may not be required for a wireless communication device to implement the various embodiments, which may apply to any form of wireless communication.

In a wireless communication device with multiple RF chains, the antennas of the RF chains may be in close proximity to each other. This close proximity may cause one RF chain to desensitize or interfere with the ability of another during the simultaneous use of the RF chains. Receiver desensitization (“desense”), or degradation of receiver sensitivity, may result from noise interference of a nearby transmitter. In particular, when two radios are close together with one transmitting on the uplink (the “aggressor”) and the other receiving on the downlink (the “victim”), signals from the transmitter may be picked up by the receiver or otherwise interfere with reception of a weaker signal (e.g., from a distant base station). As a result, the received signals may become corrupted and difficult or impossible for the victim to decode. In particular, desense of received signals presents a design and operational challenge for multi-radio devices due to the proximity of transmitter and receiver.

Multi-technology devices enable a user to connect to different mobile networks (or different accounts on the same network) while using the same multi-technology communication device. For example, a multi-technology communication device may connect to GSM, TDSCDMA, CDMA2000, WCDMA and other radio frequency networks. In the various embodiments, multi-technology communication devices may also include two RF chains so that each network communication supported by each RF chain can be accomplished concurrently.

However, multi-technology devices can suffer from interference between two communications being accomplished concurrently, such as when one communication session is transmitting (“Tx”) at the same time as another communication session is attempting to receive (“Rx”). As used herein, the term “victim” refers to the communication service or subscription suffering from interference at a given instant, and the term “aggressor” refers to the communication service or subscription whose Rx or Tx actions are causing the interference. In an example multi-technology communication device, the victim may be attempting to receive RF signals from a network while the aggressor attempts to transmit RF signals to another network. In an example of such interference, an aggressor's transmissions may de-sense the victim's reception, in which case the victim may receive the aggressor's transmissions that act as noise and interfere with the victim's ability to receive wanted RF signals.

In multi-technology communication devices, an aggressor's transmissions may cause severe impairment to the victim's ability to receive transmission. This interference may be in the form of blocking interference, harmonics, intermodulation, or other noises and distortion. Such interference may significantly degrade the victim's receiver sensitivity, link to a network, voice call quality and data throughput. These effects may result in a reduced network capacity for the affected communication service or subscription. The aggressor's transmission may also cause receiver sensitivity of the victim signal that is drastically degraded, resulting in call quality degradation, higher rates for call drops and radio link failures, and data throughput degradation, which may potentially cause the victim to lose a data connection.

Nonlinear signals of the RF chains may be to blame for desense of received signals. Often the Tx/aggressor signal frequency is a fraction of the Rx/victim signal frequency. However, multiple aggressor signals may constructively combine to form a harmonic aggressor signal to the victim signal. The harmonic aggressor signal may be strong enough to cause nonlinear interference of the victim signal.

In order to recover information from the victim signal, various circuits and processing methods may be used to remove or subtract the interfering signals from the received victim signal. However, removing or subtracting nonlinear interference from a victim signal is particularly problematic for devices having multiple RF chain, such as multi-SIM multi-active (“MSMA”) devices and for Long-Term Evolution (“LTE”) carrier aggregation, because interference experienced on one RF chain may come from multiple RF sources and thus may have unpredictable signal form. Current techniques for removing nonlinear interference from a victim signal are case specific, requiring the communications device to have knowledge of the communication technology used for the transmission and reception of signals, and the kind of interference the aggressor signal is causing.

The various embodiments include methods for removing nonlinear interference from a victim signal in digital communications by using a neural network analysis method to estimate the coefficients of the signal to be removed before a received signal is decoded. In particular, the neural network may implement supervised learning using a combination of block least squares methods and radial basis functions, in conjunction with a Hammerstein structure (e.g., a linear filter) to dynamically estimate an interference of the aggressor signals on the victim signal to be removed from the victim signal so that it may be decoded. An absolute calculation of the nonlinear interference may be mathematically difficult. Accordingly, the various embodiments provide methods that may be implemented in cost effective circuits and processing algorithms to provide an effective estimate of the interference, which when subtracted from the victim signal results in significant improvement in the recovered signal.

In various embodiments, a mobile device may use a combination block least squares/radial basis function neural network method combined with a linear filter function to estimate a function of the nonlinear interference from a set of known aggressor reference signals and a victim reference signal without having to know the type of communication technology or type, source or form of interference. The set of aggressor reference signals may be obtained from the RF chain on the mobile device supporting the aggressor reference signals. The victim reference signal may be obtained from the RF chain on the mobile device supporting the victim reference signal. These known signals may be received by the block least squares/radial basis function neural network at an input layer.

In various embodiments, the aggressor reference signal may be a complex signal that may be divided into one or more real and imaginary aggressor signals. In various embodiments, the aggressor reference signal may be used to generate a dominant kernel of aggressor signals, which may be divided into one or more real and imaginary aggressor kernels and received by the neural network at the input layer in place of the aggressor reference signal. From the input layer the block least squares/radial basis function neural network may generate aggressor kernels, and may pass the aggressor kernels to a hidden layer and an intermediate layer of the block least squares/radial basis function neural network. At the hidden layer, the block least squares/radial basis function neural network may execute a radial basis function on the aggressor kernels and pass the results to the intermediate layer. These hidden layer outputs may be combined with a set of block least squares kernels to produce a combined aggressor kernel matrix.

In various embodiments, combined aggressor kernel matrix may be passed to the intermediate layer. At the intermediate layer the block least squares kernels and hidden layer output may be augmented with one or more weight factors and linearly combined. A result of the augmentation and linear combination may be passed to an output layer. All of the outputs of the intermediate layer may again be augmented by a second set of one or more weight factors and linearly combined in a linear filter function to produce an estimation of an estimated nonlinear interference signal. The estimated nonlinear interference may then be removed from a received victim signal.

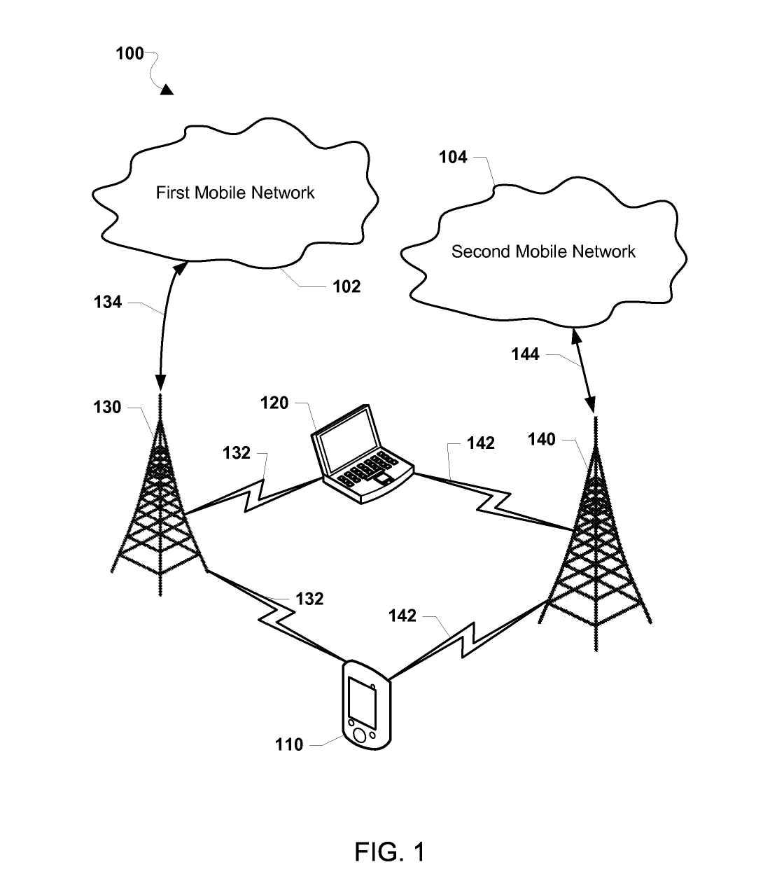

The various embodiments may be implemented in wireless communication devices that operate within a variety of communication systems 100, such as at least two mobile telephony networks, an example of which is illustrated in FIG. 1. A first mobile network 102 and a second mobile network 104 are typical mobile networks that include a plurality of cellular base stations 130 and 140. A first multi-technology communication device 110 may be in communication with the first mobile network 102 through a cellular connection 132 to a first base station 130. The first multi-technology communication device 110 may also be in communication with the second mobile network 104 through a cellular connection 142 to a second base station 140. The first base station 130 may be in communication with the first mobile network 102 over a connection 134. The second base station 140 may be in communication with the second mobile network 104 over a connection 144.

A second multi-technology communication device 120 may similarly communicate with the first mobile network 102 through a radio based communication connection such as a cellular connection 132 to a first base station 130. The second multi-technology communication device 120 may communicate with the second mobile network 104 through a radio communication connection such as a cellular connection 142 to the second base station 140. Cellular connections 132 and 142 may be made through two-way wireless communication links, such as 4G, 3G, CDMA, TDSCDMA, WCDMA, GSM, and other mobile telephony communication technologies. Other radio communication connections may include various other wireless connections, including WLANs, such as Wi-Fi based on IEEE 802.11 standards, and wireless location services, such as GPS. For example, the first wireless communications device may transmit and receive Wi-Fi communications from a network resource such as a router. Similarly, the wireless communications device may transmit and receive wireless communications with multiple Bluetooth enabled devices such as peripheral devices (e.g., keyboards, speakers, displays) as well as the second wireless communications device. The transmission and receipt of wireless communications over any and all of these radio resources may result in desense on victim signals during overlapping periods of transmission.

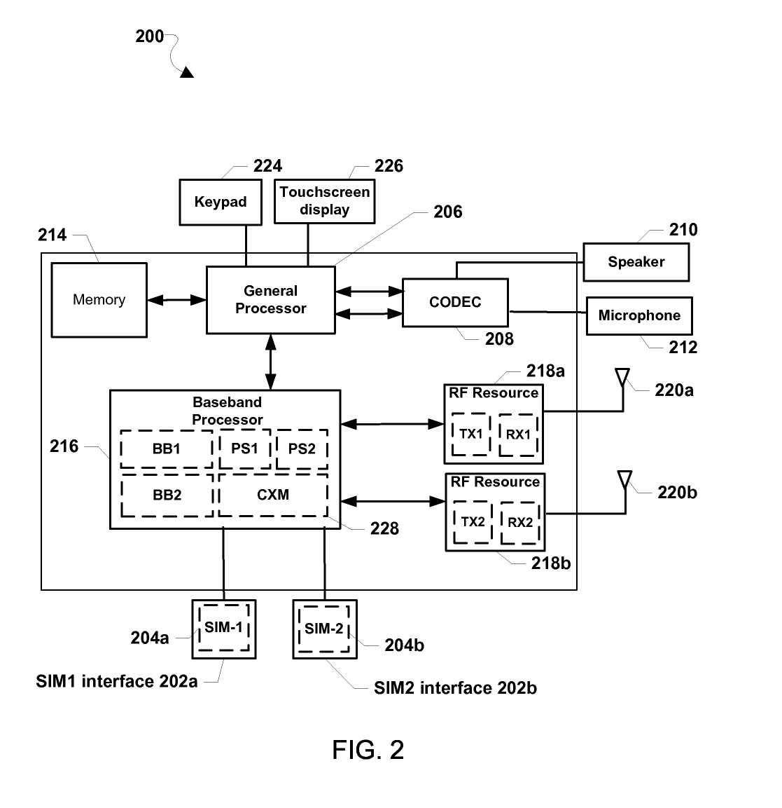

FIG. 2 illustrates various embodiments of a multi-technology communication device 200 (e.g., 110, 120 in FIG. 1) that are suitable for implementing the various embodiments. With reference to FIGS. 1 and 2, the multi-technology communication device 200 may include a first SIM interface 202a, which may receive a first identity SIM-1 204a that is associated with a first subscription. The multi-technology communication device 200 may also include a second SIM interface 202b, which may receive a second identity SIM-2 204b that is associated with a second subscription.

A SIM in the various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity (R-UIM) or a CDMA subscriber identity module (CSIM) on a card.

Each SIM may have a CPU, ROM, RAM, EEPROM and I/O circuits. A SIM used in the various embodiments may contain user account information, an international mobile subscriber identity module (IMSI), a set of SIM application toolkit (SAT) commands and storage space for phone book contacts. A SIM may further store a Home Public-Land-Mobile-Network (HPLMN) code to indicate the SIM card network operator provider. An Integrated Circuit Card Identity (ICCID) SIM serial number may be printed on the SIM for identification.

Each multi-technology communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain.

The memory 214 may store operating system (OS), as well as user application software and executable instructions. The memory 214 may also store application data, such as an array data structure.

The general purpose processor 206 and memory 214 may each be coupled to at least one baseband modem processor 216. Each SIM in the multi-technology communication device 200 (e.g., SIM-1 202a and SIM-2 202b) may be associated with a baseband-RF resource chain. Each baseband-RF resource chain may include the baseband modem processor 216 to perform baseband/modem functions for communications on a SIM, and one or more amplifiers and radios, referred to generally herein as RF resources 218a, 218b. In some embodiments, baseband-RF resource chains may interact with a shared baseband modem processor 216 (i.e., a single device that performs baseband/modem functions for all SIMs on the wireless device). Alternatively, each baseband-RF resource chain may include physically or logically separate baseband processors (e.g., BB1, BB2).

In some embodiments, the baseband modem processor 216 may be an integrated chip capable of managing the protocol stacks of each of the SIMs or subscriptions (e.g., PS1, PS1) and implementing a co-existence manager software 228 (e.g., CXM). By implementing modem software, subscription protocol stacks, and the co-existence manager software 228 on this integrated baseband modem processor 216, thread based instructions may be used on the integrated baseband modem processor 216 to communicate instructions between the software implementing the interference prediction, the mitigation techniques for co-existence issues, and the Rx and Tx operations.

The RF resources 218a, 218b may be communication circuits or transceivers that perform transmit/receive functions for the associated SIM of the wireless device. The RF resources 218a, 218b may be communication circuits that include separate transmit and receive circuitry, or may include a transceiver that combines transmitter and receiver functions. The RF resources 218a, 218b may be coupled to a wireless antenna (e.g., a first wireless antenna 220a and a second wireless antenna 220b). The RF resources 218a, 218b may also be coupled to the baseband modem processor 216.

In some embodiments, the general purpose processor 206, memory 214, baseband processor(s) 216, and RF resources 218a, 218b may be included in the multi-technology communication device 200 as a system-on-chip. In other embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the multi-technology communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive a selection of a contact from a contact list or receive a telephone number. As another example, the request to initiate the outgoing call may be in the form of a voice command received via the microphone 212. Interfaces may be provided between the various software s and functions in multi-technology communication device 200 to enable communication between them, as is known in the art.

In some embodiments, the multi-technology communication device 200 may instead be a single-technology or multiple-technology device having more or less than two RF chains. Further, various embodiments may implement, single RF chain or multiple RF chain wireless communication devices with fewer SIM cards than the number of RF chains, including without using any SIM card.

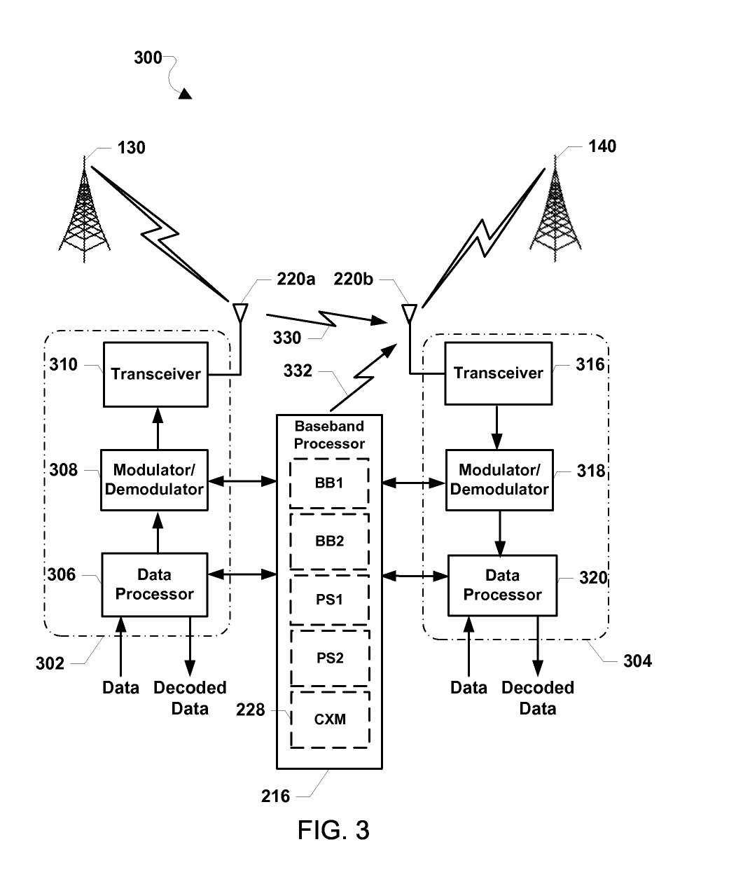

FIG. 3 is a block diagram of a communication system 300 that illustrates embodiment interactions between components of different transmit/receive chains in a multi-technology wireless communications device. With reference to FIGS. 1-3, for example, a first radio technology RF chain 302 may be one RF resource 218a, and a second radio technology RF chain 304 may be part of another RF resource 218b. In some embodiments, the first and second radio technology RF chains 302, 304 may include components operable for transmitting data. When transmitting data, a data processor 306, 320 may format, encode, and interleave data in preparation for transmission. A modulator/demodulator 308, 318 may modulate a carrier signal with encoded data, for example, by performing Gaussian minimum shift keying (GMSK). One or more transceiver circuits 310, 316 may condition the modulated signal (e.g., by filtering, amplifying, and up-converting) to generate a RF modulated signal for transmission. The RF modulated signal may be transmitted, for example, to the base station 130, 140 via an antenna, such as the antenna 220a, 220b.

The components of the first and second radio technology RF chains 302, 304 may also be operable to receive data. When receiving data, the antenna 220a, 220b may receive RF modulated signals from the base station 130, 140 for example. The one or more transceiver circuits 310, 316 may condition (e.g., filter, amplify, and down-convert) the received RF modulated signal, digitize the conditioned signal, and provide samples to the modulator/demodulator 308, 318. The modulator/demodulator 308, 318 may extract the original information-bearing signal from the modulated carrier wave, and may provide the demodulated signal to the data processor 306, 320. The data processor 306, 320 may de-interleave and decode the signal to obtain the original, decoded data, and may provide decoded data to other components in the wireless device.

Operations of the first and second radio technology RF chains 302, 304 may be controlled by a processor, such as the baseband processor(s) 216. In the various embodiments, each of the first and second radio technology RF chains 302, 304 may be implemented as circuitry that may be separated into respective receive and transmit circuits (not shown). Alternatively, the first and second radio technology RF chains 302, 304 may combine receive and transmit circuitry (e.g., as transceivers associated with SIM-1 and SIM-2 in FIG. 2).

As described, interference between the first and second radio technology RF chains 302, 304, such as de-sense and interpolation, may cause the desired signals to become corrupted and difficult or impossible to decode. For example, a transmission signal 330 sent by the first radio technology RF chain 302 may be errantly received by the second radio technology RF chain 304. In addition, electronic noise 332 from circuitry, such as the baseband processor 216, may also contribute to interference on the first and second radio technology RF chains 302, 304. To avoid such interference, the multi-technology communication device may implement various embodiment algorithms to estimate a nonlinear interference caused by the transmissions signal 330 and cancel the estimated nonlinear interference from victim signals received by the second radio technology RF chain 304.

For the purpose of providing a clear disclosure, signals received by a wireless communications device will be referred to as victim signals. However, victim signals may also be transmission signals experiencing desense caused by incoming received signals.

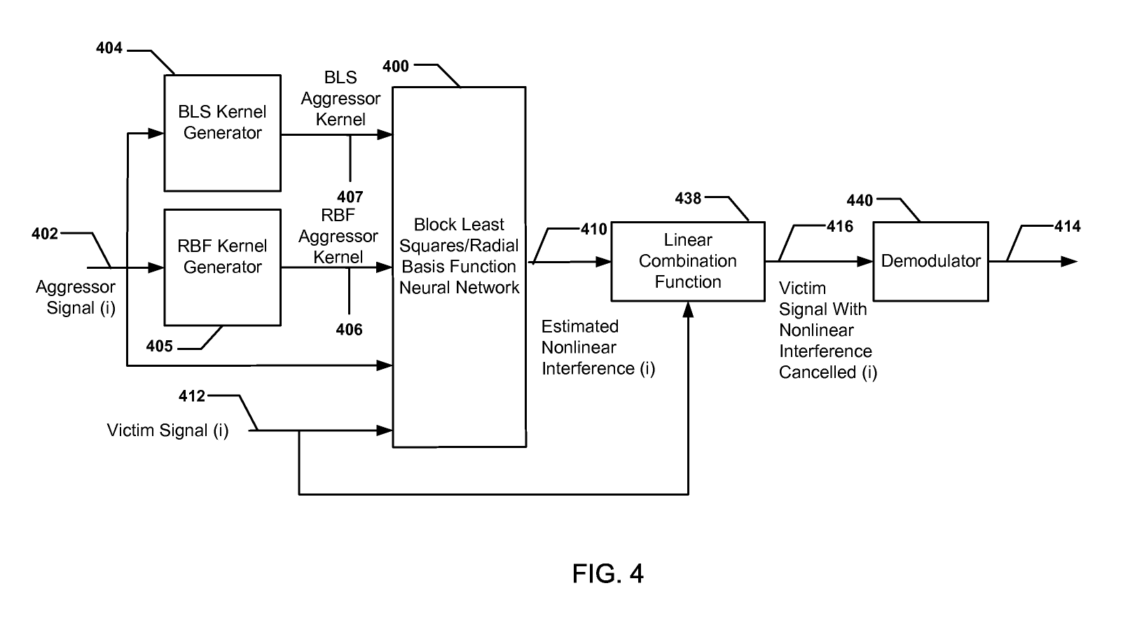

The various embodiments provide efficient algorithms that may be implemented in circuitry, in software, and in combinations of circuitry and software for estimating the nonlinear interference present in a victim signal without requiring a complete understanding or rigorous mathematical model of the aggressor signal or sources of the nonlinear interference. The embodiment algorithms are premised upon a general mathematical model of the nonlinear interferences, which for completeness is described with reference to equations 1-3. These equations are not necessarily directly solvable, and provide a model for structuring that nonlinear interference cancellation system according to various embodiments described beginning with FIG. 4.

In this mathematical model, the actual nonlinear interference signal is modeled as the interference experienced by a victim signal as a result of one or more aggressor signal(s) z(i). In this model, the actual nonlinear interference signal L(i) caused by one or more hypothetical aggressor signal(s) z(i) on a hypothetical victim signal at a time “i” may be represented by the function:

L(i)=\sqrt{JNR}·J(z(i)) [Eq. 1]

where JNR is a jammer to noise ratio (a value that could be measured at time i) and J(z(i)) is a Jacobian matrix of all hypothetical aggressor signals z(i). JNR is a value that can be calculated based on measurements but is not required in the embodiment algorithms.

Similarly, the estimated nonlinear interference signal \hat{L}(i) for a time “i” may be expressed as:

\hat{L}(i)=\sqrt{JNR}·Ĵ(z(i)) [Eq. 2]

where JNR is again the jammer to noise ratio and Ĵ(z(i)) is a Jacobian matrix of all aggressor signals z(i) (discussed in detail with reference to FIGS. 4-6A). The estimated function \hat{L}(i) is an estimate of the actual nonlinear interference signal L(i) as discussed above. This estimated nonlinear interference signal \hat{L}(i) may be the result of manipulation of the aggressor signal z(i) by the block least squares/radial basis function neural network according to various embodiments as described.

A victim signal y(i), may be the signal actually received by the multi-technology wireless communications device and may be degraded as a result of interference from the one or more aggressor signals z(i). The victim signal y(i) for the time “i” received by the multi-technology wireless communications device may be represented as the function:

y(i)=\sqrt{SNR}·x(i)+\sqrt{JNR}J(z(i))+v(i) [Eq. 3]

where elements of the victim signal y(i) may be expressed in terms of the signal-to-noise ratio (SNR), the intended receive signal represented as a function x(i), the jammer-to-noise ratio (JNR) of equation 2, the Jacobian matrix of all aggressor signals z(i), and a noise in the victim signal, such as thermal noise an inter-device interference, represented by the function v(i). As with equations 1 and 2 above, the victim signal in equation 3 is provided as a mathematical representation illustrating the relationship between the various signals.

Theoretically, the intended received signal x(i) may be obtained by rearranging the terms in Equation 3 to solve for x(i). A direct solution of these model equations may not be feasible in real time, particularly within mobile communication devices that have limited processing power. Therefore, the various embodiments employ a block least squares/radial basis function neural network to generate an estimate of the nonlinear interference signal L(i) without directly solving equation 1-3.

FIG. 4 illustrates a nonlinear interference cancellation system including a radial basis function neural network 400 that may be used to remove an estimate of the nonlinear interference from a victim signal in accordance with various embodiments. With reference to FIGS. 1-4, the radial basis function neural network with Hammerstein structure 400 may be implemented in a multi-technology wireless communications device (e.g., 110, 120, 200 in FIGS. 1 and 2) in software, general processing hardware, dedicated hardware, or a combination of any of the preceding. The radial basis function neural network with Hammerstein structure 400 may be configured to receive an aggressor signal 402 and a victim signal 412 at a time “i”. The radial basis function neural network with Hammerstein structure 400 may be configured to produce an estimated nonlinear interference signal 410 for the time “i”.

In various embodiments, The block least squares/radial basis function neural network 400 may be configured to receive a set of block least squares (BLS) aggressor kernels 407 generated by a BLS kernel generator 404. The block least squares/radial basis function neural network 400 may be further configured to receive a set of radial basis function (RBF) aggressor kernels 406 generated by an RBF kernel generator 405. The RBF and BLS kernels 406, 407 may be the result of a first kernel function (e.g., a kernel function associated with the RBF input) and a second kernel function (e.g., a kernel function associated with the BLS input) of different order, applied to all or a portion of the aggressor signal 402. The block least squares/radial basis function neural network 400 may be configured to utilize the RBF and BLS kernels to calculate an estimated nonlinear interference signal 410 for the time “i”.

In some embodiments, the block least squares/radial basis function neural network 400 may be implemented in a multi-technology wireless communications device. For any time “i”, the block least squares/radial basis function neural network 400 may be implemented to help identify an intended receive signal x(i) (i.e. the desired signal 414), the signal the communications device would have received but for experienced interference, from among the elements of the actually received victim signal 412 y(i). Given an aggressor signal 402 z(i), the block least squares/radial basis function neural network 400 may implement block least squares and neural network machine learning algorithms combined with linear filtering to produce an estimated nonlinear interference signal 410 that may be cancelled from the victim signal 412.

The estimated nonlinear interference signal 410 for the time “i” may be used by a linear combination function 438 to cancel the estimated nonlinear interference signal 410 from the victim signal 412. For example, the linear combination function 438 may subtract, add, or otherwise mathematically manipulate portions of the estimated nonlinear interference signal 410 affecting the victim signal 412. Thus, unnecessary elements of the victim signal 412 caused by aggressor signal 402 interference may be removed from the victim signal 402 and elements obscured by aggressor signal 402 interference may be recaptured. The result of the linear combination function 438 may be the victim signal with the nonlinear interference cancelled 412. A demodulator 440 may receive the victim signal with the nonlinear interference cancelled 412 and demodulate it to produce the desired signal 414.

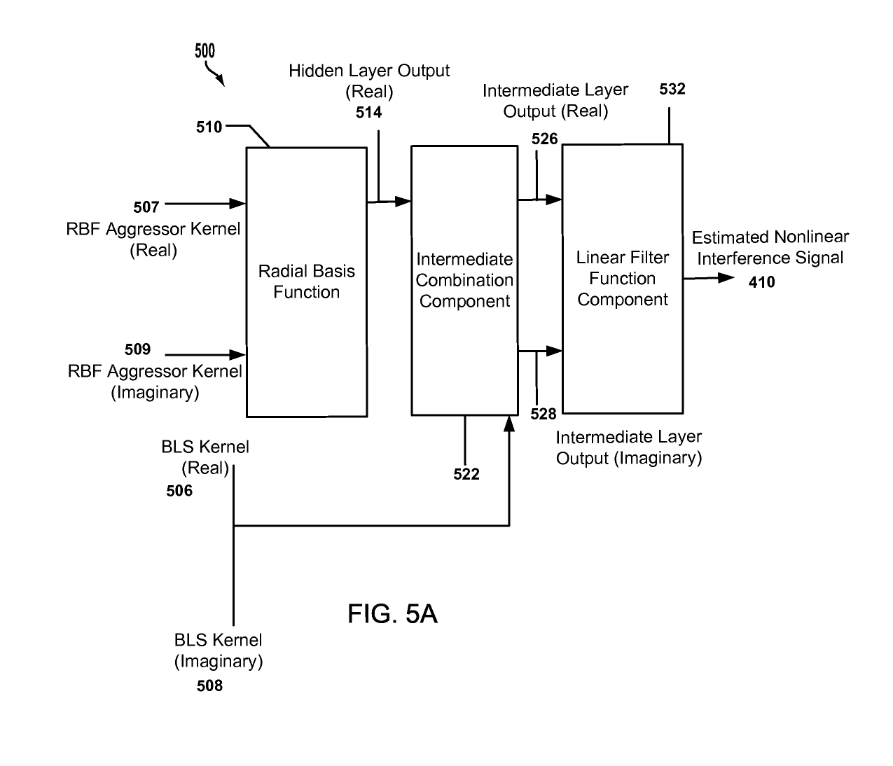

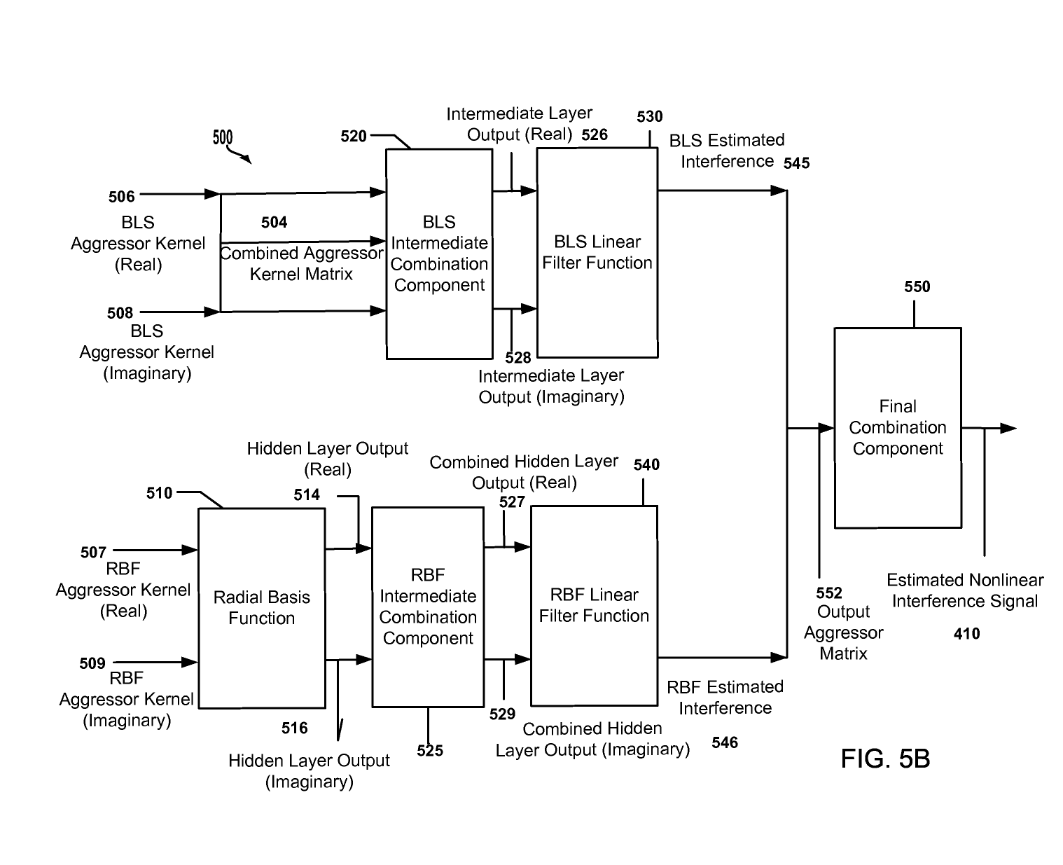

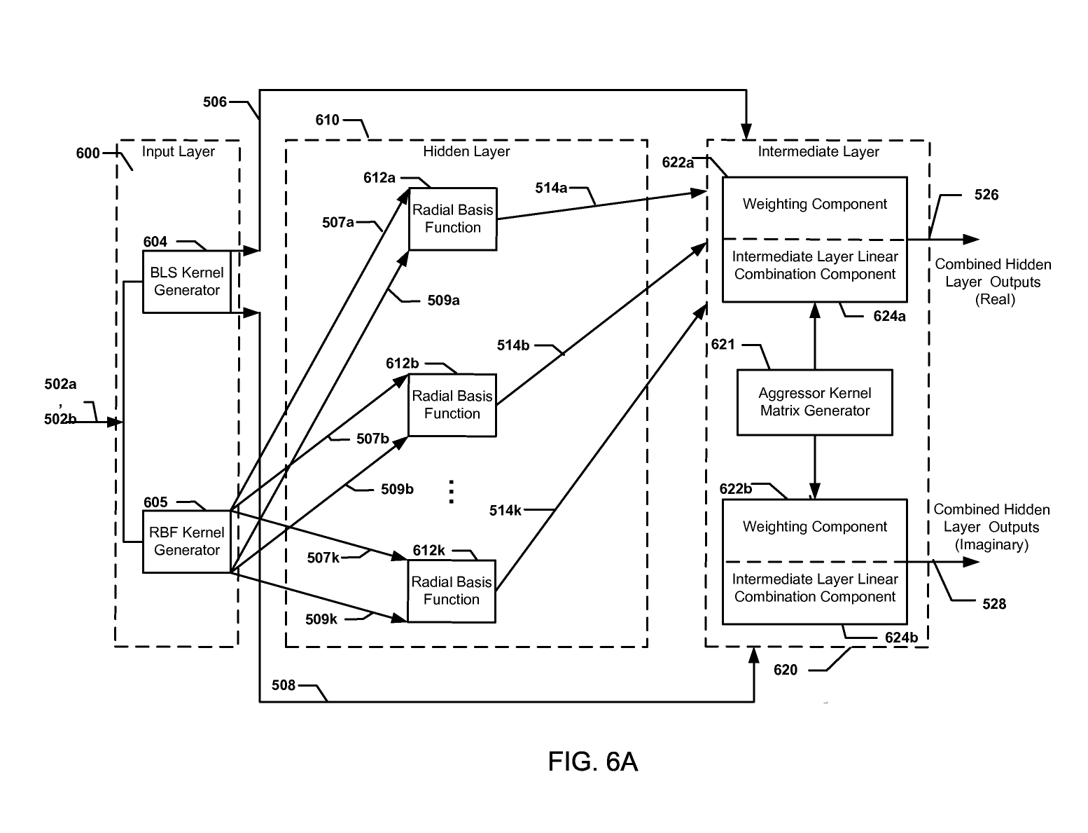

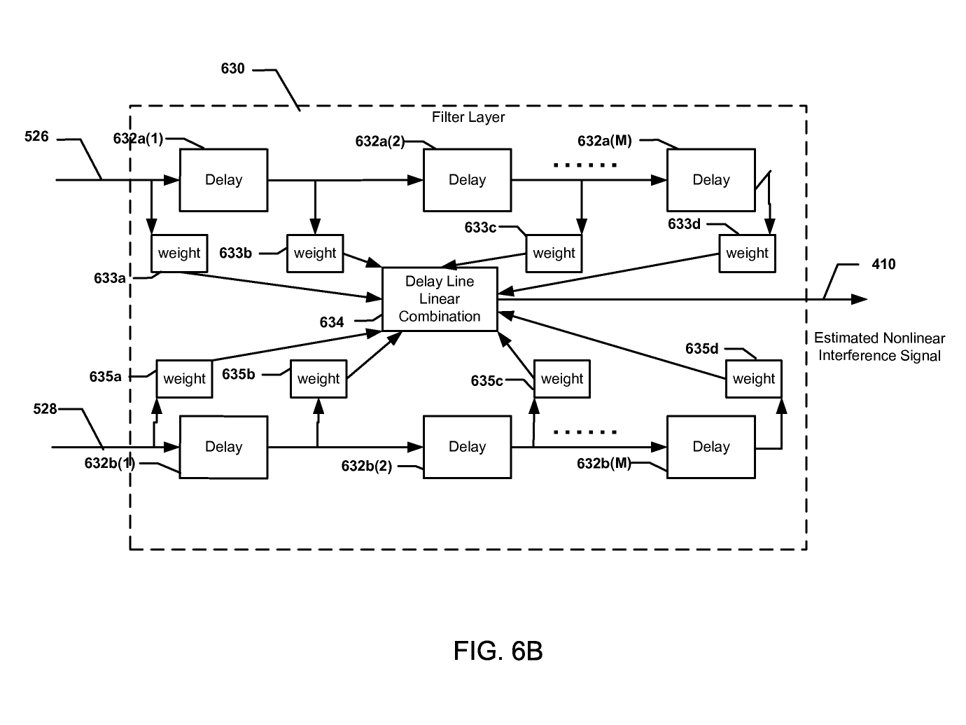

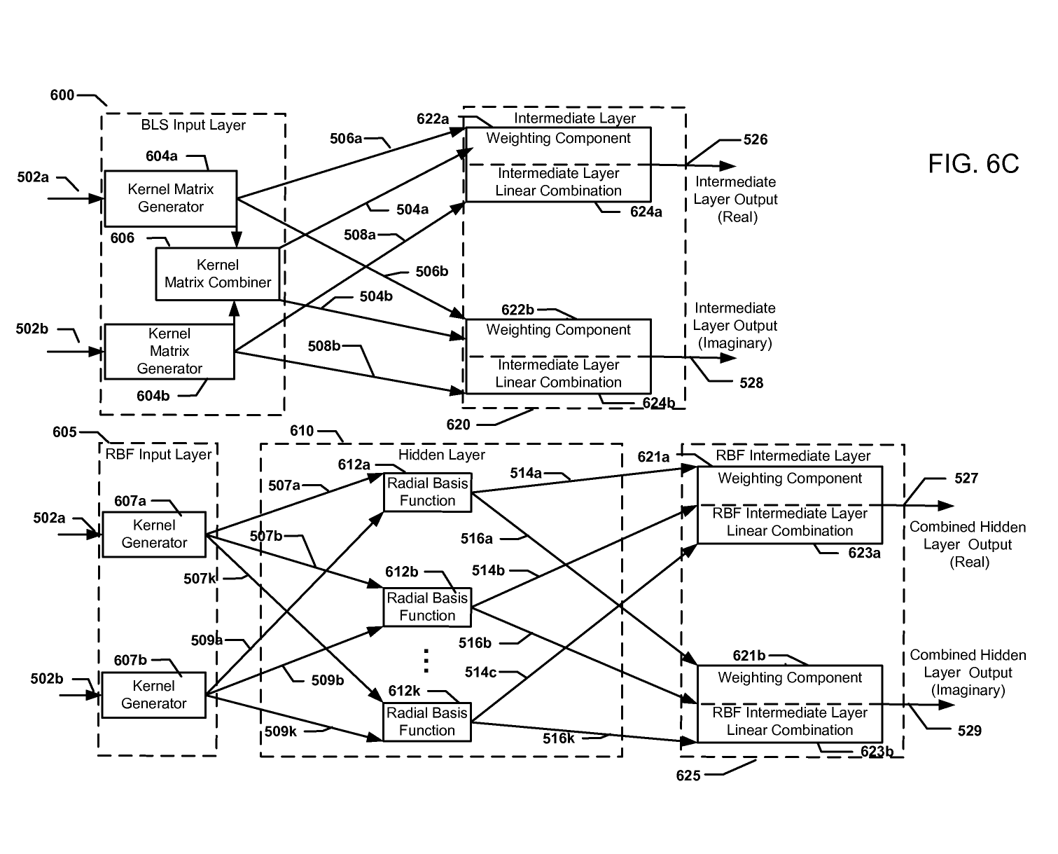

In various embodiments, the block least squares interference filter 400 may include computer implementations of block least squares machine learning algorithms. One or more aggressor signals 402 z(i) may be provided as input to the block least squares interference filter 400 as will be discussed in greater detail with reference to FIGS. 5-6A. The aggressor input(s) may be manipulated by the block least squares/radial basis function neural network 400 in a series of mathematical operations and estimations to generate the estimated nonlinear interference signal 410. Because of the mathematical complexity associated with calculation of an actual nonlinear interference signal, machine learning algorithms and linear filter functions (e.g., Hammerstein structure) may be implemented to produce an estimate of an experienced nonlinear interference signal such as the estimated nonlinear interference signal 410. As such, the various formulas described herein are mathematical representations of actual and estimated signals that are utilized or produced by the block least squares/radial basis function neural network 400. These mathematical representations may not be actively calculated by the block least squares/radial basis function neural network 400, but are provided to enable one of ordinary skill in the art to realize the relationships between elements of the various signals as they are manipulated by the operations described herein.

As discussed with reference to equations 1 and 2 above, the estimated nonlinear interference signal 410 may be described in terms of one or more aggressor signals 402 z(i). Thus, the production of the estimated nonlinear interference signal 410 may depend on the manipulation of the aggressor signals 402 by the block least squares/radial basis function neural network 400. In some embodiments, the block least squares/radial basis function neural network 400 may accept the result of a kernel function executed on the aggressor signal 402 (i.e., aggressor kernel(s)) and may produce multiple aggressor kernel matrices for use in estimation of nonlinear interference. These embodiments will be discussed in greater detail with reference to FIGS. 5-6A.

Generating an estimated nonlinear interference signal 410 for the time “i” may be accomplished by the block least squares/radial basis function neural network 400 in a semi-blind and universal manner. In other words, the block least squares/radial basis function neural network 400 may calculate the estimated nonlinear interference signal 410 knowing some information about the radio access technology used by the multi-technology wireless communications device or the kind of interference occurring on the victim signal 412. This information may include the radio band of the aggressor and/or victim signal and other transmission information. In embodiments in which the aggressor signal 402 is converted into an aggressor kernel, the order of the kernel function may be dictated by the transmission information. For example, in various embodiments, aggressor signals transmitted on a particular radio band may require manipulation using a kernel function of order “b” to produce an aggressor kernel.

The aggressor signal 402 may have a mathematical representation that is a complex structure with imaginary and real elements. Thus, the aggressor signal may include a real aggressor signal component and an imaginary aggressor signal component. The real aggressor signal component may be represented by z_{Real}(i), and the imaginary aggressor signal component may be represented by z_{Imaginary}(i). As discussed further with reference to FIG. 6A, an intermediate layer of the block least squares/radial basis function neural network may produce a jammer signal estimate (e.g., intermediate layer outputs 526, 528 in FIG. 5) having a complex structure. Like the aggressor signal components, the complex jammer signal estimate may include a real jammer signal estimate component and an imaginary jammer signal estimate component. A linear filter, such as a finite impulse response filter, may receive a real jammer signal estimate component and an imaginary jammer signal estimate component. The linear filter may use the real and imaginary jammer signal estimate components to produce a complex estimated nonlinear interference signal (i.e., an estimated nonlinear interference signal having a complex structure), as discussed further with reference to FIGS. 5-6A. The complex estimated nonlinear interference signal may include an estimated nonlinear interference component (real) and an estimated nonlinear interference component (imaginary).

As described, the aggressor signal 402 may be represented as a function z(i) for the time “i”. The kernel generation function employed by the kernel generator 404, 405 may be one of various kernel functions such a harmonic or exponential expansion of order “r”, for example z(i). The resulting aggressor kernel may have a complex structure with both real and imaginary components. Thus, the aggressor kernel \hat{z}(i) may be represented as:

\hat{z}_{Real}(i)=Real part of ker(z(i)) [Eq. 4a]

\hat{z}_{Imaginary}(i)=Imaginary part of ker(z(i)) [Eq. 4b]

where ker(z(i)) is the application of a selected kernel function on the aggressor signal 402 z(i) by the kernel generator 404. The kernel generator 404, 405 may utilize the generated real and imaginary aggressor kernels to build an aggressor kernel matrix as will be discussed in greater detail with reference FIGS. 5-6A.

The aggressor kernel matrix 504 may be divided into two component matrices, a real kernel matrix and an imaginary kernel matrix. A number of elements in each of the component matrices may be determined by the order of kernel function. For example, a kernel function of order=7 may produce four aggressor kernel components and thus the associated component matrix may have four elements. Each element may correspond to an execution of a kernel function of order 1, 3, 5, and 7. The real and imaginary aggressor kernel matrices may be combined into a combined aggressor kernel.

FIGS. 5A-B illustrate examples of the flow of inputs and outputs through the block least squares/radial basis function neural network 400 in FIG. 4 in accordance with various embodiments. With reference to FIGS. 1-5A the block least squares/radial basis function neural network 400 may include a radial basis function 510, an intermediate combination component 522, a linear filter function component 532, which may further the calculation of the estimated nonlinear interference signal 410 for time “i”.

The radial basis function 510 may include one or more nodes (i.e., there may be 1 to “k” nodes). The number of nodes may be dictated by the level of accuracy desired for the estimated nonlinear interference. Larger quantities of nodes may provide more accurate estimates of nonlinear interference signals, but may require greater computational resources.

In various embodiments, each node φₖ(i) of the radial basis function 510 may produce one or more of a hidden layer output signal (real) 514 and a hidden layer output (imaginary) 516. For example, embodiments such as those shown in FIG. 5A may include radial basis function 510 that only produces a hidden layer output signal (real) 514. Embodiments such as those shown in FIG. 5B may include radial basis functions 510 that produce both a hidden layer output signal (real) 514 and a hidden layer output signal (imaginary)) 516. The hidden layer output signals 514 and/or 516 may be passed as an input to the intermediate combination 522 (shown in FIG. 5A) or an RBF intermediate compination component 525 (shown in FIG. 5B), which will be described in further detail with reference to FIGS. 6A-6B. Each node of the radial basis function 510 may be represented as:

$${ϕ}_{k} ( i ) = exp ( - \frac{{‖ \underline{z} ( i ) - {\underline{c}}_{k} ‖}^{2}}{2 {σ}_{k}^{2}} \qquad [ Eq . 5 ]$$

where “k” is a current node number from t to a total number of nodes “K”, z(i) is an aggressor signal at time “i”, cₖ is a radial basis function centroid associated with node “k”, and σₖ² is a scalar constant referred to as the “spread” of the data distribution associated with node “k”. Equation 5 is a mathematical model of a representative radial basis function that may be used in the estimated of nonlinear interference signal 410 using an aggressor signal 402.

In embodiments such as that illustrated in FIG. 5A, the real and imaginary kernel matrices, and the combined aggressor kernel matrix, may be represented in terms of both the BLS kernels and the hidden layer outputs φ(i) for a time “i”.

A_{Real}=[\hat{z}_{Re,1}(i),φ₁(i),\hat{z}_{Re,2}(i),φ₂(i) . . . \hat{z}_{Re,p}(i),φₚ(i)] [Eq. 6]

A_{imaginary}=[\hat{z}_{Im,1}(i),\hat{z}_{Im,2}(i), . . . \hat{z}_{Im,p}(i)] [Eq. 7]

A_{S}=[A_{Re},A_{Im}] [Eq. 8]

where A_{Real} is the real component of the combined aggressor kernel matrix, \hat{z}_{Re,p}(i) is the real component of the p-th aggressor kernel, φₚ(i) is the p-th radial basis function output, A_{Imaginary} is the imaginary component of the combined aggressor kernel matrix, \hat{z}_{Im,p}(i) is the imaginary component of the p-th aggressor kernel function, and A_{S} is a combined aggressor kernel matrix.

As shown in FIG. 5B, each node of the radial basis function 510 may receive the RBF aggressor kernel (real) and (imaginary) 507, 509. Execution of the radial basis function 510 may produce a hidden layer output (real) 514 for each node. With reference to FIG. 5A, the hidden layer output 514 and sets of real BLS aggressor kernels 506 and imaginary BLS aggressor kernels 508 may be passed to the Intermediate combination component 522, and combined into a real aggressor kernel matrix, an imaginary aggressor kernel matrix, and a combined aggressor kernel matrix. The real and imaginary aggressor kernel matrices may be augmented with one or more weight factors, during or prior to being inputted into the intermediate combination component 520. The intermediate combination component 520 may receive the hidden layer output 514 and the real BLS aggressor kernels 506, the imaginary BLS aggressor kernels 508, and generate the real and imaginary aggressor kernel matrices, and combined aggressor kernel matrix. The real and imaginary aggressor kernel matrices may be augmented with weight factors, and may further be subjected to a multiplication or a summation resulting in an intermediate layer output (real) 526 and intermediate layer output (imaginary) 528.

At the intermediate layer, the real and imaginary aggressor kernel matrices may be combined to create a combined aggressor kernel matrix. The intermediate layer may include a set of weights represented by “ω” defined by a least squares function operating on the combined aggressor kernel matrix. An exemplary least squares function may be expressed by the function:

\hat{w}=(A_{S}^{T}(i)A_{S}(i))⁻¹A_{S}^{T}(i)y(i) [Eq. 9a]

where \hat{w}=arg min_{w}∥y(i)−A_{S}(i)w∥² [Eq. 9b]

where \hat{ω} is a matrix of weight factors, Aₛ(i) is the combined aggressor kernel matrix 504, and y(i) is the victim signal 412.

The results of the augmentation and linear combination of the real BLS aggressor kernel matrix and the imaginary BLS aggressor kernel matrix for the time “i” may be expressed in terms of the weight factors and represented by the following functions:

\hat{s}(i)=A_{S}(i)\hat{w} [Eq. 10]

where ŝ(i) is a vector comprising elements that represent individual intermediate layer outputs for a time “i”, Aₛ(i) is a combined aggressor matrix, and w are one or more weight factors.

In various embodiments, the real and imaginary results of the augmentation and linear combination may be combined into the real and imaginary intermediate layer outputs 526, 528, which may be matrices. These intermediate layer output elements may be combined with previous intermediate layer outputs to produce intermediate layer outputs 526, 528 that may produce a more accurate estimation of the nonlinear interference. The real and imaginary results of the augmentation and linear combination are contained in the intermediate layer output 526, 528 S_{Re}(i), S_{Im}(i), which may be matrices. Intermediate layer output matrices may be represented in terms of the augmentation and linear combination results for time “i” by the functions:

S(i)_{N×L}=[\hat{s}(i)\hat{s}(i−1) . . . \hat{s}(i+L−1)] [Eq. 11a]

S_{S}(i)=[S_{Re}(i)S_{Im}(i)] [Eq. 11b]

where S(i)_{N×L} is a matrix containing intermediate layer output vectors from a time “I” (current) to a time “i+L-1” for a sample size “N”, and S_{S}(i) is a general representation of the intermediate layer outputs (i.e., a combined intermediate layer output matrix) comprising both hidden layer outputs 526, 528 S_{Re}(i), S_{Im}(i).

The intermediate layer outputs 526, 528 may be passed to a linear filter function component 532 of the output layer. The linear filter function component 532 may have a Hammerstein structure or other finite impulse response filter function. In various embodiments, the intermediate layer outputs 526, 528 may be summed and augmented by a second set of one or more weight factors during execution of the linear filter function component 532 to produce an estimated nonlinear interference signal 410. The weight factors may be determined using a least squares method on the intermediate layer outputs 526, 528. The second set of one or more weights “u” may be described in terms of the intermediate layer outputs 526, 528 as the function:

\hat{u}=(S_{S}^{T}(i)S_{S}(i))⁻¹S_{S}^{T}(i)y(i) [Eq. 12a]

where \hat{u}=arg minᵤ∥y(i)−S_{S}(i)u∥^{2[Eq.} 12b]

where û is a matrix of weight factors, Sₛ(i) is the combined intermediate layer output matrix (i.e., 526 and 528 combined), and y(i) is the victim signal 412.

Results of the linear filter function component 532 may be an estimated nonlinear interference signal 410. The estimated nonlinear interference signal 410 \hat{L}(i) for the time “i” may be represented by the function:

\hat{L}(i)=Sₛ(i)\hat{u} [Eq. 13]

where \hat{L}(i) is an estimated nonlinear interference signal 410, Sₛ(i) is a combined intermediate layer outputs, and û is a matrix of a second set of one or more weight factors. Thus, the estimated nonlinear interference signal 410 is dependent on both the real and imaginary intermediate layer outputs 526, 528. The produced estimated non-linear interference may be cancelled from the received victim to obtain an intended receive signal “x(i)”.

In various embodiments, the radial basis function may be executed prior to or during generation of the BLS kernels. As described above, the radial basis function nodes may produce hidden layer outputs 514, which may be combined with the BLS kernels to form the aggressor matrices used in intermediate layer calculations.

With reference to FIGS. 1-5B, the block least squares/radial basis function neural network interference filter 400 may include a radial basis function 510, an RBF intermediate combination component 525, an RBF linear filter function component 540, a BLS intermediate combination component 520, a BLS linear filter function component 530, and a final combination component 550, which may further the calculation of the estimated nonlinear interference signal 410 for time “i”. In some embodiments, the blocked least squares/radial basis function neural network may operate on the BLS kernels and RBF kernels in parallel. The RBF aggressor kernel (real) 507 and RBF aggressor kernel (imaginary) 509 may be passed to the radial basis function 510. The radial basis function 510 may execute multiple radial basis functions on the kernel components to produce hidden layer output 514. In parallel execution embodiments, an RBF intermediate layer may receive the real and imaginary hidden layer output 514 and augment the outputs with one or more weight factors. An RBF intermediate combination component 525 may be performed on the augmented hidden layer output(s) to produce combined hidden layer outputs 527, 529.

The number of nodes “K”, may be dictated by the scale of the neural network implementation (e.g., enterprise level networks having substantial interference issues may require larger numbers of nodes). In some embodiments, an RBF aggressor kernel (507, 509) generated from the aggressor signal 402 at time “i” may be an input in the radial basis function 510. The aggressor signal 402 may be separated into a real aggressor signal component 502a and an imaginary aggressor signal component 502b prior to or during the kernel generation process. The resultant aggressor kernel may comprise an RBF aggressor kernel component (real) 507 and an RBF aggressor kernel component (imaginary) 509. In some embodiments the aggressor kernels generated by the aggressor kernel generator 406, 407 may be vectors. In such embodiments, the RBF aggressor kernel component (real) 507, and the RBF aggressor kernel component (imaginary) 509 may be treated as elements of vectors. Each node of the radial basis function 510 may also produce a hidden layer output signal (real) 514. Hidden layer output signal 514 may be passed to an RBF intermediate Combination Component 525 in the intermediate layer. RBF intermediate Combination Component 525 which may produce a combined hidden layer output (real) 527 and a combined hidden layer output (imaginary) 529. These combined hidden layer outputs 527, 529 may be passed to an RBF linear filter Function Component 540 of the output layer.

The combined hidden layer outputs 527, 529 S_{Real}(i), S_{Imaginary}(i) may be expressed in terms of the linear combination of the hidden layer output 514, and the augmenting weight factors. Hidden layer output 514 may be represented by φ(i) (e.g., the output of a radial basis function execution) for a time “i”. The combined hidden layer outputs 527, 529 for the time “i” may be represented by the functions:

S_{Real}(i)=[W_{1,1,RBF}φ₁+ . . . w_{1,K,RBF}φ_{K}] [Eq. 14]

S_{imaginary}(i)=[W_{2,1,RBF}φ₁+ . . . w_{2,K,RBF}φ_{K}] [Eq. 15]

where s_{Real}(i) is a real component of a combined hidden layer output, w_{P,k,RBF} are RBF weight factors where p=1 for real components and p=2 for imaginary components, k=a number of radial basis function nodes, φ_{K} is a hidden layer output for a radial basis node “k”, and S_{imaginary}(i) is an imaginary component of a combined hidden layer output.

The combined hidden layer outputs 527, 529 may be passed to an RBF linear filter Function Component 540 of the RBF filter layer. At the RBF filter layer, a second set of one or more RBF weight factors may augment the combined hidden layer outputs 527, 529. A linear combination may be executed on the augmented hidden layer outputs. The RBF linear filter Function Component 540 may be executed in the same manner as described with respect to the integrated block least squares/radial basis function model. An output of the RBF linear filter Function Component 540 may be an RBF estimated interference 546. The RBF estimated interference 546 may be passed to a final Combination Component 550 executed on both the RBF estimated interference 546 and the BLS estimated interference 545 at an output layer to obtain an estimated nonlinear interference signal 410.

At the same time as execution of the radial basis function neural network, the block least squares functions may execute. In some embodiments, a real BLS aggressor kernel matrix and an imaginary BLS aggressor kernel matrix generated from the aggressor signal at time “i” may be passed to the BLS intermediate combination component 520. The combined aggressor kernel matrix 504 used to generate one or more BLS weight factors. The aggressor signal 402 may be separated into real and imaginary parts prior to or during the kernel matrix generation process, such that the resultant aggressor kernel matrix may include a real BLS aggressor kernel matrix and an imaginary BLS aggressor kernel matrix. A combined aggressor kernel matrix may be generated by inserting both the real BLS aggressor kernel matrix and the imaginary BLS aggressor kernel matrix into a single matrix. The aggressor kernel matrices for the BLS functions may be represented as:

A_{Real}=[,\hat{z}_{Re,1}(i),\hat{z}_{Re,2}(i), . . . ,\hat{z}_{Re,p}(i)] [Eq. 16]

A_{Imaginary}=[\hat{z}_{Im,1}(i),\hat{z}_{Im,2}(i), . . . \hat{z}_{Im,p}(i)] [Eq. 17]

A_{S}=[A_{Re},A_{Im}] [Eq. 18]

where A_{Real}(i) is the real component of the combined aggressor kernel matrix, i.e. real aggressor kernel matrix, N and M are a number of signal samples, K is a number of aggressor kernels, A_{Imaginary}(i) is the imaginary component of the combined aggressor kernel matrix, i.e. imaginary aggressor kernel matrix, and A_{S}(i) is a combined aggressor kernel matrix.

The real and imaginary BLS aggressor kernel matrices may be passed to a BLS intermediate layer for augmentation and linear combination. The BLS intermediate layer, weight augmentation, and BLS linear combination may execute in the manner discussed above with respect to integrated block least squares/radial basis function models. Generation of one or more BLS intermediate layer weight factors may also be accomplished using the least squares method disclosed above. In some embodiments, the BLS intermediate combination component 520 may produce an intermediate layer output (real) 526 and an intermediate layer output (imaginary) 528, which may be passed to a BLS linear filter function component 530 of the BLS filter layer. Like the RBF filter layer or the integrated model filter layer, the BLS filter layer may include the linear filter function component 530. Thus, the BL linear filter layer may also include a second set of one or more BLS weight factors and a linear combination. The result of the BLS linear filter function component 530 may be a BLS estimated interference 545 that may be passed to the final Combination Component 550 of the output layer.

An output layer of the parallel mixed-model block least squares/radial basis function neural network may have a final Combination Component 550, in which a third set of one or more weight factors may augment the BLS estimated interference 545 and the RBF estimated interference 546. The RBF estimated interference 546 and BLS estimated interference 545 may be combined into an output aggressor matrix 552. The output aggressor matrix 552 may be represented in terms of the RBF estimated interference 546 and the BLS estimated interference 545, by the function:

B(i)_{N×2}=[\hat{L}_{BLS}(i)\hat{L}_{RBF}(i)] [Eq. 19]

where B(i)_{N×2} is the output aggressor matrix for N signal samples, \hat{L}_{BLS}(i) is the BLS estimated interference 545, and \hat{L}_{RBF}(i) is the RBF estimated interference 546.

In some embodiments, the output aggressor matrix 552 may be used to calculate a third set of one or more weight factors. A final Combination Component 550 may augment the RBF estimated interference 546 and BLS estimated interference 545 with the third set of one or more weight factors. The weight factors may be represented by the function:

\hat{v}=(B^{H}(i)B(i))⁻¹B^{H}(i)y(i)

where \hat{v}=arg minᵥ∥y(i)−B(i)v∥² [Eq. 21]

where \hat{v} is a matrix of weight factors, Bₛ(i) is the output aggressor matrix, and y(i) is the victim signal 412.

In various embodiments the third set of one or more weight factors may be applied prior to or during a linear combination of the RBF estimated interference 546 and the BLS estimated interference 545. A result of the final combination function 550 may the estimated nonlinear interference signal 410 \hat{L}(i) for the time “i”. The estimated nonlinear interference may be represented by the following function:

\hat{L}(i)=B(i)\hat{v} [Eq. 22]

where \hat{L}(i) is the estimated nonlinear interference, B(i) is the output aggressor matrix, and \hat{v} is a matrix of weight factors.

An estimated nonlinear interference may be cancelled from the received nonlinear interference signal y(i) to obtain an intended receive signal “x(I)”.

FIG. 6A illustrates interactions between components of the block least squares/radial basis function neural network (e.g., 400 in FIG. 4 and FIG. 5) with an aggressor signal input (e.g., 402 in FIG. 4,) in accordance with various embodiments. With reference to FIGS. 1-6A, the block least squares/radial basis function neural network may include an input layer 600, a hidden layer 610, an intermediate layer 620, and a filter layer 630. For purposes of clarity, the block least squares/radial basis function neural network is described with reference to a single aggressor signal; however, multiple aggressor signals may interfere with the victim signal and consequently multiple aggressor signals may be used to produce the estimated nonlinear interference signal.

In an integrated multi-model block least squares/radial basis function neural network, an input layer 600 may receive the real and imaginary aggressor signal components 502a, 502b (real and imaginary components of aggressor signal 402) and pass it to a BLS kernel generator 604 and RBF kernel generator 605. Kernel generators 604, 605 may apply one or more kernel functions to the signal, resulting in a set of real BLS aggressor kernels 506a-b, a set of imaginary BLS aggressor kernels 508a-b, a set of real RBF aggressor kernels 507a-k, and a set of imaginary RBF aggressor kernels 509a-k. In some embodiments, the aggressor signal may have been separated into a real component 502a and an imaginary 502b component before being passed to the kernel generators 604, 605. The RBF aggressor kernels 507a-k, 509a-k may be passed to a hidden layer 610 as inputs to radial basis function nodes 612a-k. The RBF aggressor kernel real components 507a-k may be passed to corresponding radial basis function nodes 612a-k. Similarly, the RBF aggressor kernel imaginary components 509a-k may be passed to and received by corresponding radial basis function nodes 612a-k.

Each of the BLS aggressor kernels 506, 508 may be passed directly to an intermediate layer 620. The set of real BLS aggressor kernels 506a-b may be passed to corresponding weighting component 622a and intermediate layer linear combination component 624a of the intermediate layer 620. Similarly, the set of imaginary BLS aggressor kernels 508a-b may be passed to and received by corresponding weighting component 622b and intermediate layer linear combination component 624b.

In various embodiments, the radial basis function may be trained prior to processing RBF aggressor kernel components 507a-k, 509a-k. The radial basis function may be trained by estimating the centroids and spread. Centroid estimation may include use of a k-means clustering algorithm to produce a random sample of k centroids segregated into k clusters. A set of sample aggressor signals may be passed to the radial basis function and the results compared. Centroids may be adjusted until the results converge.

The radial basis function nodes 612a-k of the hidden layer 610 may execute a radial basis function on received RBF aggressor kernel (real) 507a-k and RBF aggressor kernel (imaginary) 509a-k to obtain hidden layer output 514a-k φₖ(i) for each current node “k”. Each radial basis function node 612a-k of the hidden layer 610 may pass hidden layer output 514 to the intermediate layer 620. Unlike the RBF aggressor kernel inputs 507, 509, the hidden layer output 514 may include only real component 514. There may be “K” hidden layer outputs 514 for a hidden layer 610 having “k” nodes.

In various embodiments, the hidden layer output 514 may be combined with the BLS aggressor kernels 506, 508 to generate a combined aggressor kernel matrix. Generation of the combined aggressor kernel matrix may occur at an aggressor kernel matrix generator 621 of the intermediate layer 620. The combined aggressor kernel matrix may be passed within the intermediate layer 620. A block least squares function may be executed on the combined aggressor kernel matrix to produce a set of weight factors. These weight factors may be associated with weighting components 622a-b and used to augment the received BLS aggressor kernel 506, 508 and hidden layer output 514. In some embodiments, an imaginary component of the weight factors may be applied to the received imaginary components 508, and a real component of the weight factors applied to the received real components 506, 514 during the intermediate layer augmentation 622a-b.

At the intermediate layer 620, the BLS aggressor kernels 506, 508 and hidden layer output 514 may be augmented by weighting components 622a, 622b, which may augment the BLS aggressor kernels 506, 508 and hidden layer output 514 with one or more weight factors to produce augmented BLS aggressor kernels and augmented hidden layer outputs. In various embodiments, weighting components 622a may be applied to the real BLS aggressor kernel 506 and hidden layer output 514. The weighting components 622b may be applied to the imaginary BLS aggressor kernel 508. The weighting factors may be applied prior to, during, or after summation of the real BLS aggressor kernels 506, the imaginary BLS aggressor kernels 508, and hidden layer output 514 by the intermediate layer linear combination components 624a-b. The augmentation and linear combination of the real BLS aggressor kernels 506, the imaginary BLS aggressor kernels 508 and hidden layer output 514 may produce an intermediate layer output (real) 526 and an intermediate layer output (imaginary) 528, which may be passed to a filter layer 630.

FIG. 6B illustrates interactions between components of a filter layer of a block least squares/radial basis function neural network 400 in FIG. 4 in accordance with various embodiments. With reference to FIGS. 1-6B, the filter layer 630 may include a linear filer function 530 that may be executed to filter the real and intermediate layer outputs 526, 528. A result of the filtering may be the production of an estimated nonlinear interference signal 410.

Each of the intermediate layer outputs 526 and 528 may be passed to the filter layer 630 including a linear filter function component 530. The linear filter function component 530 may be executed to filter the intermediate layer outputs 526, 528 and produce an estimated nonlinear interference signal 410. In some embodiments, the filter layer 630 may include a finite impulse response filter having a delay line 632a(1)-(M) for the intermediate layer output (real) 526, and a delay line 632b(1)-(M) for the intermediate layer output (imaginary) 528. A second set of weighting components 633a-d, 635a-d may augment the intermediate layer outputs 526, 528 with one or more weight factors at each operation of the delay lines 632a(1)-(M), 632b(1)-(M). In some embodiments, the weighting component 633a-d may augment the intermediate layer output (real) 526 and the weighting component 635a-d may augment the intermediate layer output (imaginary) 528. The one or more weight factors of the second set of weighting components 633a-d, 635a-d may be generated in a manner similar to that of the first weight factors. In an embodiment, the intermediate layer outputs 526, 528 may be combined and passed to the output layer 630. A least squares function may be executed on the combined intermediate layer outputs to produce a second set of weight factors. The second set of weight factors may be associated with weighting components 633a-d, 635a-d and used to augment the real and intermediate components of the intermediate layer outputs 526, 528, respectively.

The filter layer 630 including the linear filter function 530 may further include a delay line linear combination component 634 for combining the real and imaginary intermediate layer outputs 526, 528. The intermediate layer outputs 526, 528 by be combined (e.g., summed or multiplied) as they are processed by the respective delay lines 632a(1)-(M), 632b(1)-(M) and augmented with one or more weight factors. Each operation of the delay lines and their associated weighting component are referred to as a “tap” of the linear filter function. The linear filter function may have “M” taps and thus may have M−1 weighting components (i.e., d=M+1). A result of the filter layer 630 may be an estimated nonlinear interference signal 410.

In various embodiments, the second set of one or more weight factors may be associated with weighting components 633a-d, 635a-d and used to augment the real and intermediate components of the intermediate layer outputs 526, 528, respectively. In some embodiments, an imaginary component of the second set of one or more weight factors may be applied to the intermediate layer output (imaginary) 528, and a real component of the second set of one or more weight factors applied to the intermediate layer output (real) 526 during the intermediate layer augmentation 633a-d, 635a-d.

In some embodiments, the estimated nonlinear interference signal 410 may be cancelled or subtracted from the victim signal 412 so that the victim signal 412 may be decoded and understood by the multi-technology communications device. In some embodiments, the estimated nonlinear interference signal 410 may be used to train the weight factors of the block least squares interference filter.

FIG. 6C illustrates interactions between components of the block least squares/radial basis function neural network (e.g., 400 in FIG. 4 and FIG. 5) with an aggressor signal input (e.g., 402 in FIG. 4,) in accordance with various embodiments. With reference to FIGS. 1-6C, the block least squares/radial basis function neural network may include an input layer 600, a hidden layer 610, an intermediate layer 620, an RBF intermediate layer 625, a filter layer 630, an RBF filter layer 640, and/or an output layer 650. For purposes of clarity, the block least squares/radial basis function neural network is described with reference to a single aggressor signal; however, multiple aggressor signals may interfere with the victim signal and consequently multiple aggressor signals may be used to produce the estimated nonlinear interference signal.

In various embodiments, the block least squares/radial basis function neural network may execute the BLS and RBF operations in parallel. The block least squares/radial basis function neural network may have an input layer 600 (for BLS input) and an RBF input layer 605 at which aggressor signals 502a-b (i.e., the real and imaginary components of aggressor signal 402) to may be received. The input layer 600 may receive the real and imaginary aggressor signal components 502a, 502b and pass them to a kernel matrix generator 604a-b, which may apply a kernel function to the signal resulting in a BLS aggressor kernel matrix (real) 506, BLS aggressor kernel matrix (imaginary) 508, and a combined aggressor kernel matrix 504a-k. Each of the BLS aggressor kernel matrix (real) 506 and BLS aggressor kernel matrix (imaginary) 508 may be passed to an intermediate layer 620. The aggressor kernel matrix (real) 506 may be passed to corresponding augmentation (i.e., weighting component 622a) and combination (i.e., intermediate layer linear combination component 624a) functions. Similarly, the aggressor kernel matrix (imaginary) 508 may be passed to corresponding augmentation (i.e., weighting component 622b) and combination (i.e., intermediate layer linear combination component 624b) functions.

In various embodiments, the combined aggressor kernel matrix 504a-k may also be passed to the BLS intermediate layer 620. A least squares function may be executed on the combined aggressor kernel matrix to produce a set of one or more weight factors. In some embodiments, weight factors may be associated with weighting components 622a-b and may be used to augment the received BLS aggressor kernel matrices 506, 508. In some embodiments, an imaginary component of the weight factors may augment the received BLS aggressor kernel matrix (imaginary) 508, and a real component of the weight factors may augment the received BLS aggressor kernel matrix (real) 506 during the intermediate layer augmentation 622a-b.

At the BLS intermediate layer 620, the BLS aggressor kernel matrix (real) 506 and BLS aggressor kernel matrix (imaginary) 508 may be augmented by weighting components 622a, 622b. The weighting components 622a, 622b may augment each element of the BLS aggressor kernel matrices 506, 508 with one or more weight factors to produce augmented BLS aggressor kernel matrices. In various embodiments, the weighting component 622a augment the BLS aggressor kernel matrix (real) 506. Similarly, weighting component 622b may augment the aggressor kernel matrix (imaginary) 508. The weighting components 622a, 622b may be applied prior to, during, or after summation of the BLS aggressor kernel matrices 506, 508 by the linear combination components 624a-b. The weight factor augmentation and linear combination of the aggressor kernel matrices 506, 508 may produce an intermediate layer output (real) 526 and an intermediate layer output (imaginary) 528, which are passed to a filter layer 630.

In various embodiments, a radial basis function arm of the block least squares/radial basis function neural network may execute concurrent with execution of the block least squares arm. The RBF input layer 605 may pass the aggressor signals 502a-b to the kernel generator 607a-b. The kernel generator 607a-b may apply a kernel function to the aggressor signals 502a-b to produce an RBF aggressor kernel having a real component 507 and an imaginary 509 component. The kernel function used to generate the RBF kernels may be different from that used to generate the BLS aggressor kernel matrices. Each of the RBF aggressor kernel (real) 507a-k and RBF aggressor kernel (imaginary) 509a-k may be passed to each radial basis function nodes 612a-k of a hidden layer 610. The RBF aggressor kernel (real) 507a-k may be passed to and received by corresponding radial basis functions 612a-c. Similarly, the RBF aggressor kernel (imaginary) 509a-k may be passed to corresponding radial basis function nodes 612a-k. As described above, the radial basis function nodes 612a-k may be trained prior to processing RBF aggressor kernel components 507, 509.

The radial basis function node 612a-k of the hidden layer 610 may execute a radial basis function on each received RBF aggressor kernel (real) 507a-k and RBF aggressor kernel (imaginary) 509a-k to produce hidden layer outputs 514, 516. As with the RBF aggressor kernels 507, 509, the hidden layer outputs 514, 516 may include a real component 514 and an imaginary component 516. There may be “K” hidden layer outputs (real) 514 and “K” hidden layer outputs (imaginary) 516 for a hidden layer 610 having “k” nodes.

At the RBF intermediate layer 625, the hidden layer outputs (real) 514a-k and hidden layer outputs (imaginary) 516a-k may be augmented by weighting components 621a-b, which may augment each of the hidden layer outputs 514a-k, 516a-k with one or more weight factors to produce augmented hidden layer outputs. In various embodiments, a weighting component 621a may be applied to the hidden layer (real) outputs 514a-k, and weighting components 621b may be applied to the hidden layer (imaginary) outputs 516a-k. The weighting components may be applied prior to, during, or after summation of the hidden layer outputs 514, 516 by the RBF intermediate layer linear combination components 623a-b. The weight factor augmentation and linear combination of the hidden layer outputs 514a-k, 516a-k may produce a combined hidden layer output (real) 527 and a combined hidden layer output (imaginary) 529. The real and imaginary combined hidden layer outputs 527, 529 may be passed to an RBF filter layer 640.

FIG. 6D illustrates interactions between components of filter layers of a block least squares/radial basis function neural network 400 in FIG. 4 in accordance with various embodiments. With reference to FIGS. 1-6D, the filter layers 630, 640 may include multiple linear filer function component 530, 540, which may be executed to filter the real and intermediate layer outputs 526, 528 at a filter layer 30, and on real and imaginary combined hidden layer outputs at an RBF filter layer 640. A result of the filter layers 630 and 640 may be combined to produce an estimated nonlinear interference signal 410.

In various embodiments a filter layer 630 may receive intermediate layer outputs 526, 528 and an intermediate output layer matrix comprised of the real and imaginary components of the intermediate layer output. The filter layer 630 may execute a linear filter function on the intermediate layer outputs 526, 528 including augmentation with one or more weight factors and a linear combination. As described with respect to the integrated block least squares/radial basis function neural network model of FIGS. 6A-6B, the one or more weight factors may be generated by executing a least squares function on the intermediate layer output matrix. A result of the linear filter function may be a BLS estimated interference 545.

In various embodiments an RBF filter layer 640 may receive the combined hidden layer outputs 527, 529. The RBF filter layer 640 may execute a linear filter function in a manner similar to that described with reference to FIG. 6B above. The linear filter function may include augmentation by one or more weight factors and a linear combination. A result of the linear filter function may be an RBF estimated interference 546. Estimation of the one or more weight factors of the RBF filter layer may differ from that of the weight factors of the filter layer 630.

In various embodiments, RBF weight training may occur prior to execution of the radial basis function neural network. In some embodiments, the weight factors may be trained using a least squares method. In some embodiments, initial weight training may include setting the output layer linear filter function taps to 1, 0, 0 . . . , thereby indicating that the filter is empty. The intermediate layer weighting components 621 (“w’) may then be trained according to the functions:

y(i)=(φ(i)^{T}w+v(i) [Eq. 23]

φ(i)=[φ₁(i)φ₂(i) . . . φₖ(i)]^{T} [Eq. 24]

w=(\hat{φ}^{T}\hat{φ})⁻¹\hat{φ}^{T}y [Eq. 25]

\hat{φ}=[φ(i)φ(i+1) . . . φ(i+N−1)]^{T} [Eq. 26]

where y(i) is a victim signal 412, φ(i)^{T} is a transposed matrix of hidden layer output signals for the time “i”, “w” are intermediate layer weight factors, and “\hat{φ}” is a matrix of hidden layer output signals for times “i” through “i+N−1” (N may be equal to “M” the number of delay line taps).

The trained intermediate layer weights may be used to train RBF filter layer weighting components 641a-d, 643a-d (“a”) of the linear filter function. For example, taps of a finite impulse response filter may be trained by using the estimated intermediate layer weight components 621 (i.e., weight factors) to produce combined hidden layer outputs 527, 529 (ŝ_{Real}(i),ŝ_{Imaginary}(i) that may be passed to the linear filter function component 530 of the RBF filter layer 640. In this manner, the output layer weighting components 633 may be trained according to the functions:

y(i)=\hat{s}(i)^{T}a+n(i) [Eq. 27]

\hat{s}(i)=[\hat{s}(i−1) . . . \hat{s}(i−Mem)]^{T} [Eq. 28]

\hat{a}=(Ŝ^{T}Ŝ)⁻¹Ŝ^{T}y [Eq. 29]

Ŝ=[ŝ(i)\hat{s}(i+1) . . . \hat{s}(i+N−1)]^{T} [Eq. 30]

where y(i) is a victim signal 412, s(i)^{T} is a transposed matrix of combined hidden layer output signals for the time “i”, “a” are RBF filter layer weight factors, and “S” is a matrix of combined hidden layer output signals for times “I” through “i+N−1” (N may be equal to “M” the number of delay line taps).

In various embodiments, an output layer 650 may receive the BLS estimated interference 545 from filter layer 630 and the RBF estimated interference 546 from RBF filter layer 640. The BLS estimated interference 545 and the RBF estimated interference 546 may be passed to an output matrix combiner 652, which may combine the BLS and RBF estimated interference 545, 546 into an output aggressor matrix 542. The output aggressor matrix 542, the BLS estimated interference 545, and the RBF estimated interference 546 may be passed to an weighting component 654 and linear combination component 656. A set of one or more weight factors may be generated by executing a least squares function on the output aggressor matrix 542. In various embodiments, the BLS estimated interference 545 and RBF estimated interference 546 may be augmented with the one or more weight factors prior to or during linear combination by the output layer linear combination 656. The output of the output layer 650 may be an estimated nonlinear interference 562.

In some embodiments, the error of the estimated nonlinear interference signal 410 may be compared to an error threshold to determine whether the error is acceptable. Determining that the error present in an estimation of the nonlinear interference signal is unacceptable may prompt the block least squares/radial basis function neural network to train or retrain the weight factors to reduce the error in the estimated nonlinear interference signal 410. The weight factors may be trained using a variety of optimization algorithms, for example least squares, gradient decent, the Gauss-Newton algorithm, and the Levenberg-Marquardt algorithm. Training of the weight factors may be regressively executed to further reduce the error of the estimated nonlinear interference signal 410. In some embodiments, satisfactory weight factors may be reused for subsequent nonlinear interference estimations. The reuse of previously determined weight factors may be based on one or more parameters, such as time since the last adjustment of the weight factors and how the error in the estimated nonlinear interference signal 410 compares to the error threshold, and the like.

In the various examples, components of the block least squares/radial basis function neural network are shown individually or in combination. It should be understood that these examples are not limiting and the various other configurations of the components are considered. For example, the nodes 612a-k and their components are illustrated as separate components. However, any of the nodes 612a-k and/or components may be embodied in combination with other components, and multiples of the same component may be embodied in a single component.

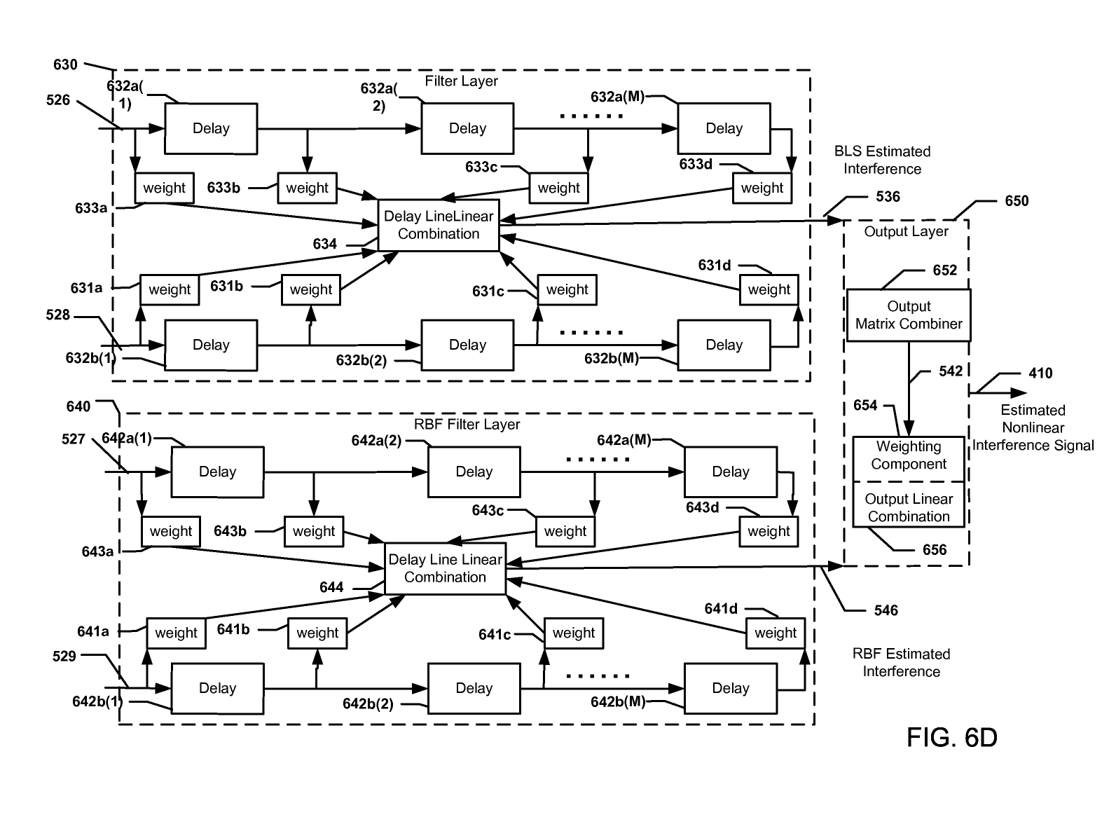

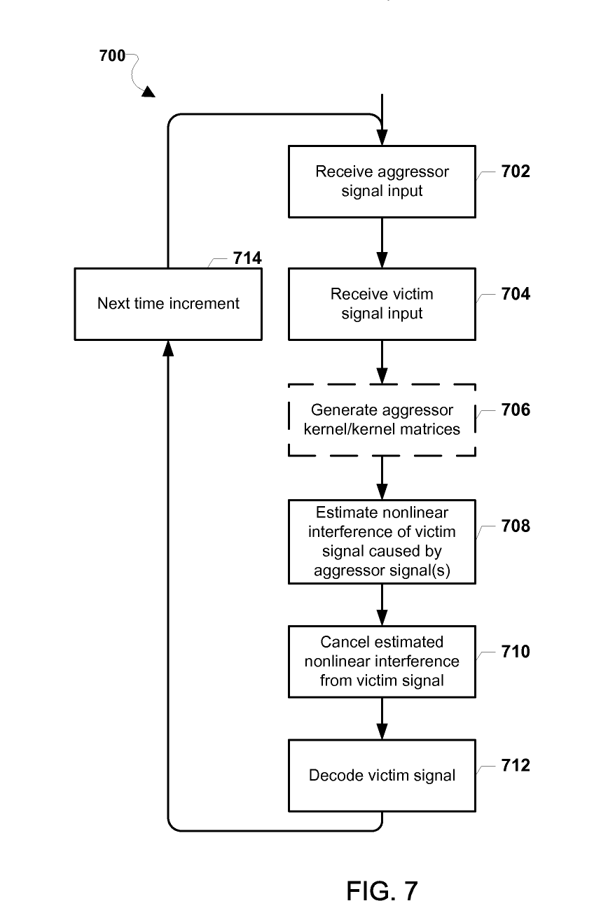

FIG. 7 illustrates a method 700 for canceling nonlinear interference from a received signal using a block least squares/radial basis function neural network (e.g., 400 in FIG. 4 and FIG. 5) in a multi-technology wireless communications device in accordance with various embodiments. With reference to FIGS. 1-7, the method 700 may be executed in a computing device (e.g., 110, 120, 200) using software, general purpose or dedicated hardware, or a combination of software and hardware, such as the general purpose processor 206, baseband processor 216, or the like. In block 702, the multi-technology communication device may receive an aggressor signal. The aggressor signal may be received by a first radio access technology of the multi-technology communication device from a transmission of a second radio access technology of the same multi-technology communication device.

In block 704, the multi-technology communication device may receive a victim signal. The victim signal may be received by the first radio access technology of the multi-technology communication device from a transmitting source device separate from the multi-technology communication device. The victim signal may initially be unaffected by interference when transmitted from the transmitting source device. However, the victim signal may experience interference caused by the aggressor signal during transmission to the multi-technology communication device.

In block 706, the multi-technology communication device may generate a dominant aggressor kernel matrix from the aggressor signal. The aggressor kernel may include a real component and an imaginary component. The aggressor signal received by the first radio access technology of the multi-technology communication device may be separated into a real component and an imaginary component. These components may be passed as inputs to a kernel function such as a harmonic or exponential function (e.g., a harmonic expansion), where the order of the kernel function may be dictated by information known about the transmission technology of the aggressor or victim signal. The kernel function may be executed (r/2)+1 times where “r” is the highest order of the kernel function, and for each execution of the kernel function from order 1, 3, 5 . . . “r”. In parallel execution mixed-model block least squares/radial basis function neural networks the kernel function result may be added to an aggressor kernel matrix. The kernel matrix generator may produce a real BLS aggressor kernel matrix, an imaginary BLS aggressor kernel matrix and a combined BLS aggressor kernel matrix including both the real BLS aggressor kernel matrix and the imaginary aggressor kernel matrix. In an integrated execution mixed-model block least squares/radial basis function neural network, only a set of RBF kernels and a set of BLS kernels may be generated during the kernel generation process. A combined matrix may be generated after execution of a radial basis function.

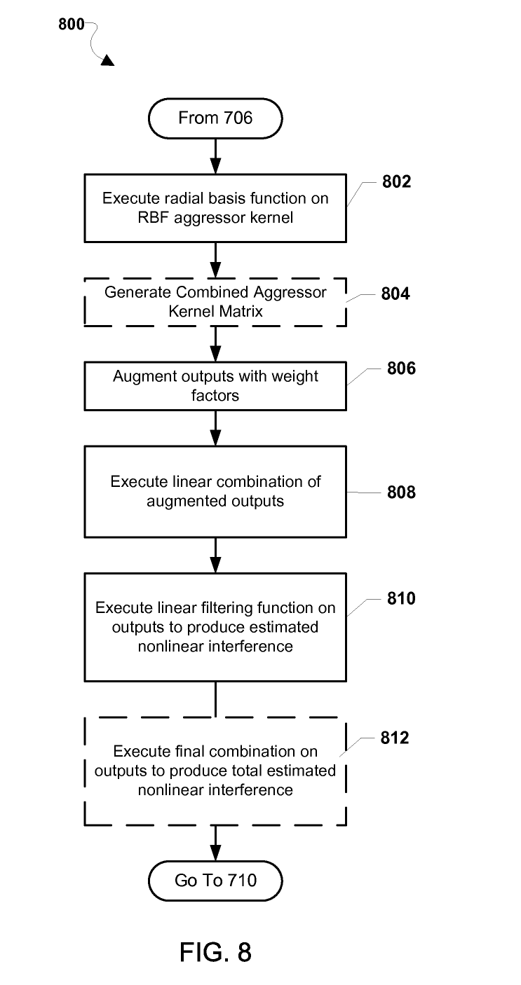

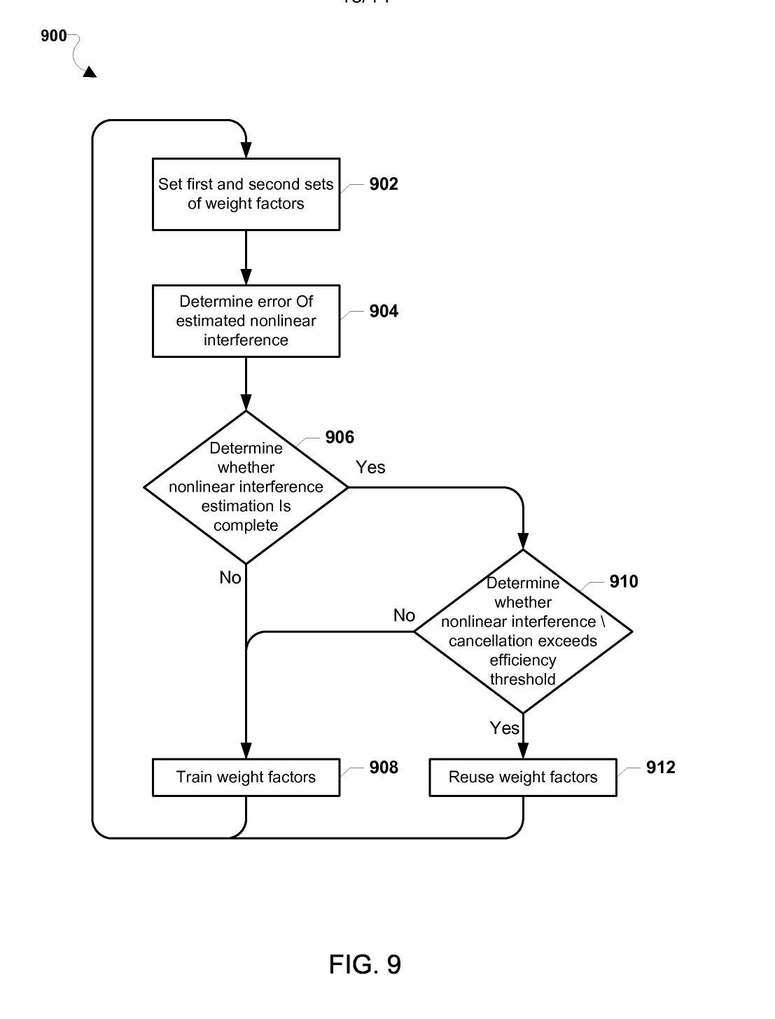

In block 708, the multi-technology communication device may estimate the nonlinear interference of the victim signal caused by the aggressor signal(s). This estimation of the nonlinear interference is discussed in further detail (e.g., with reference to FIGS. 8 and 9). In block 710, the multi-technology communication device may cancel an estimated nonlinear interference signal from the victim signal. Canceling or removing the estimated nonlinear interference from the victim signal may be implemented in a variety of known ways, such as filtration, transformation, extraction, reconstruction, and suppression. In block 712, the multi-technology communication device may decode the victim signal without presence of the interference by the aggressor signal(s). In block 714, the multi-technology communication device may advance to the next time interval “i” (e.g., move to the current time interval) and begin the process again with regard to aggressor and victim signals for the current time “i”.

FIG. 8 illustrates a method 800 for estimating nonlinear interference using a block least squares interference filter (e.g., 400 in FIG. 4 and FIG. 5) in a multi-technology wireless communications device in accordance with various embodiments. With reference to FIGS. 1-8, the method 800 may be executed in a computing device (e.g., 110, 120, 200) using software, general purpose or dedicated hardware, or a combination of software and hardware, such as the general purpose processor 206, baseband processor 216, or the like. In one example, the method may be performed by a processor of the multi-technology communication device. The method 800 may be included in method 700 in FIG. 7 as part of block 708. As described above, the victim signal and the aggressor signal(s) may be used by the multi-technology communication device as input signals for the least squares/radial basis function neural network. The aggressor signal(s) may be received by the input layer of the least squares/radial basis function neural network. Aggressor kernels block least squares/radial basis function and an optional aggressor kernel matrices (real and imaginary) and a combined aggressor kernel matrix, generated from the aggressor signal(s) may be used as input for use in calculating an estimated nonlinear interference.

in block 802 the multi-technology communication device may execute a radial basis function for nodes of the hidden layer to produce a hidden layer outputs. The radial basis function may include any known radial basis functions suitable for signal processing, including a Gaussian function. The results of the radial basis function execution are 2K hidden layer outputs, where “K” is the number of nodes and each node produces a real hidden layer output component and an imaginary hidden layer output component. These hidden layer outputs may be passed to an intermediate layer for augmentation and linear combination.

In optional block 804, the multi-technology communication device may generate a combined aggressor kernel matrix. In embodiments employing integrated execution block least squares/radial basis function neural networks, generating the combined aggressor kernel matrix may include combining the hidden layer outputs (real) and (imaginary) and the BLS kernels (real) and (imaginary) into a single matrix. In block 806, the multi-technology communication device may augment the aggressor kernels and/or aggressor kernel matrices with a first set of weight factors. As described above, the weight factors may be generated using the combined aggressor kernel matrix, and may, be preprogrammed, and/or trained as described with reference to FIG. 9. Alternatively, the one or more weight factors for the RBF intermediate layer of the parallel execution block least squares/radial basis function neural network may be trained using a least squares function and sample aggressor signals.

In block 808, the multi-technology communication device may execute a linear combination of the BLS kernels and hidden layer outputs, or aggressor kernel matrix (real) and (imaginary) and hidden layer outputs, augmented by the first set of weight factors. In some embodiments, the augmentation and linear combination may be executed through mathematical and/or logical operations. The operations implementing the augmentation may result in a multiplication of a respective weight factor with a respective aggressor kernel matrix element. The operations implementing the linear combination may result in the summation of the augmented aggressor kernels, hidden layer outputs, and/or aggressor kernel matrices. In some embodiments, multiplication of weight factors with the aggressor kernels, hidden layer outputs, and/or aggressor kernel matrices may occur during the summation such that a weight factor is multiplied by an element at subsequent iterations of the summation. The linear combination of the augmented elements may produce the intermediate layer outputs. Like the aggressor kernel, the intermediate layer output may be a matrix having an element representing a real component and an element representing an imaginary component. These intermediate layer outputs may be passed as input to an output layer. In various embodiments using parallel execution block least squares/radial basis function neural networks, an output of the RBF intermediate layer may be combined hidden layer outputs, and an output of the BLS intermediate layer may be intermediate layer outputs.

In determination block 810, the multi-technology communication device may execute a linear filter function at one or more filter layers. The linear filter function may be an impulse response filter such as a linear finite impulse response filter, which may sample, augment and combine the intermediate layer outputs and/or combined hidden layer outputs. The linear filter function may have a delay line for each of the intermediate layer output real and imaginary components, and may iteratively process the components. Processed output components may be augmented with an element of a second set of one or more weight factors and linearly combined. In some embodiments, the augmentation and linear combination may be executed through mathematical and/or logical operations. The linear filter function may include a multiplication of one or more weight factors with respective intermediate layer outputs. The augmentation of intermediate layer outputs may occur during the summation such that a weight factor is multiplied by a post-sampling, intermediate layer output. The augmented post-sampling intermediate layer outputs are thus linearly combined at each set of the delay lines to produce a single estimated linear interference signal.

In optional block 812, the multi-technology communication device may execute a final augmentation and linear combination on the outputs of the linear filter functions. In embodiments implementing parallel execution block least squares/radial basis function neural networks, there may be an output of the filter layer, a BLS estimated interference, and an output of the RBF filter layer, an RBF estimated interference. The BLS and RBF estimated interference may be combined at an output layer. The BLS estimated interference and the RBF estimated interference may be augmented with a set of weight factors and linearly combined to produce an estimated nonlinear interference, which may be cancelled from the received victim signal.

FIG. 9 illustrates a method 900 for training weight factors for use in a block least squares/radial basis function neural network (e.g., 400 in FIG. 4 and FIG. 5) in a multi-technology wireless communications device in accordance with various embodiments. With reference to FIGS. 1-9, the method 900 may be executed in a computing device (e.g., 110, 120, 200) using software, general purpose or dedicated hardware, or a combination of software and hardware, such as the general purpose processor 206, baseband processor 216, or the like. In block 902, the multi-technology communication device may select the weight factors for augmenting the aggressor kernel matrices and the second set of weight factors for use in the linear filter function. As described, in various embodiments, the weight factors may be determined at random, be preprogrammed, and/or trained. In some embodiments the weight factors may be trained using a series of mathematical operations in which the first weight factors are determined using the combined aggressor kernel matrix. During training, the second set of weight factors is determined using the intermediate layer outputs and a second set of mathematical operations.

In block 904, the multi-technology communication device may determine an error present in the estimate of the nonlinear interference. Various known methods for determining the error of a function may be used to determine the error in block 904. In some embodiments, the error calculation may be for the mean square error of the estimated nonlinear interference compared with the nonlinear interference signal caused by the aggressor signal(s).

In determination block 906, the multi-technology communication device may determine whether the estimation of the nonlinear interference is complete. Estimation of the nonlinear interference may be considered to be complete at such time as the block least squares interference filter has finished execution and an estimated nonlinear interference signal has been obtained (i.e., the real and imaginary estimated nonlinear interference have been combined). In response to determining that the estimation of the nonlinear interference is incomplete (i.e., determination block 906=“No”), the multi-technology communication device may train the weight factors in block 908. In various embodiments, the weight factors may be trained using a variety of optimization algorithms, for example least squares, gradient decent, the Gauss-Newton algorithm, and the Levenberg-Marquardt algorithm. Training of the weight factors may be regressively executed to further reduce the error of the estimated nonlinear interference. The multi-technology communication device may continue selecting weight factors for augmenting the aggressor kernel matrices in block 902. Selection may include the newly trained weight factors.

In response to determining that the estimation of the nonlinear interference is complete (i.e., determination block 906=“Yes”), the multi-technology communication device may determine whether the nonlinear interference cancellation exceeds an efficiency threshold in determination block 910. The determination of whether the nonlinear interference cancellation exceeds the efficiency threshold may be a measure of whether the nonlinear interference is cancelled sufficient to enable the multi-technology communication device to decode and use the victim signal. The efficiency threshold may be a precalculated or predetermined value based on historical observations of a level of accuracy present in an estimated nonlinear interference signal that is necessary to enable proper decoding of a victim signal. In some embodiments, the efficiency threshold may be based on the error value determination of the nonlinear interference in block 904, in which the error level may be compared to an acceptable error level. In some embodiments, the efficiency threshold may be based on a success rate for decoding and using the victim signal.

In response to determining that the nonlinear interference cancellation does not exceed the efficiency threshold (i.e., determination block 910=“No”), the multi-technology communication device may continue to train the weight factors in block 908. Training the weight factors may reduce the amount of error in the estimated nonlinear interference so that the cancellation of the estimated nonlinear interference may result in greater success of decoding and using the victim signal.

In response to determining that the nonlinear interference cancellation does exceed the efficiency threshold (i.e., determination block 910=“Yes”), the multi-technology communication device may reuse the weight factors for subsequent estimation and cancellation of nonlinear interference in block 912. As described, the multi-technology communication device may not always train the weight factors when estimating the nonlinear interference. The nonlinear interference caused by the one or more aggressor signals may vary by different amounts under various conditions. In some embodiments, the variation in the nonlinear interference may be small enough that the previously trained weight factors may result in a sufficiently accurate estimated nonlinear interference that further training is unnecessary. Determining when to train the weight factors or reuse the weight factors may be based on one or more criteria, including time, measurements of the aggressor signal(s), victim signal quality, and nonlinear interference noise cancellation efficiency, for example including error of the estimated nonlinear interference and/or success of decoding and using the victim signal.

In some embodiments, the method 900 may be executed at various times before, during, or after the execution of the method 700 and the method 800. For example, the method 900 may be executed to calculate at least some of the weight factors before they are used to augment the aggressor kernel matrices in blocks 804. In some embodiments, certain blocks of the method 900 the method may not execute contiguously, but may instead execute interspersed with the blocks of the methods 700, 800.

In other words, the methods may manage interference such as signal interference (e.g., non-linear interference) that is received in a multi-technology communication device. Managing or analyzing interference may include filtering a received aggressor signal using a multi-model neural network, or interference filter. The multi-model neural network may include a number of layers (input layer, hidden layer, output layer, etc.), in which different mathematical operations are executed, thereby extracting a numerical representation of estimated interference from the received aggressor signal. The multi-technology communication device may receive an aggressor signal (i.e., a signal interfering with or impeding another received signal) at an input layer of the multi-model neural network. The multi-technology communication device may generate a set of block least squares (BLS) kernels and a set of radial basis function (RBF) kernels in which the sets of kernels may contain both real and imaginary elements or components (i.e., elements represented by real numbers and elements represented by imaginary numbers). The multi-technology communication device may execute a nonlinear radial basis function on the set of RBF kernels at a hidden layer to produce hidden layer outputs. The hidden layer may include multiple nodes, each receiving one or more elements of the RBF kernels from the set of RBF kernels and executing the radial basis function on the kernels resulting in the hidden layer outputs. The multi-technology communication device may augment the hidden layer outputs and the BLS kernels with weight factors (weights, weighting components) at an intermediate layer of the multi-model neural network to produce augmented or combined hidden layer outputs. Augmentation may include multiplying each result of the radial basis function execution by a corresponding weight element (i.e., a multiplier). The multi-technology communication device may also linearly combine, sum, or add, the augmented hidden layer outputs and BLS kernels at the intermediate layer to produce real intermediate layer outputs, and imaginary intermediate layer outputs. The multi-technology communication device may execute a linear filter function, FIR filter, finite impulse response filter, or Hammerstein structure on both the real intermediate layer outputs and the imaginary intermediate layer outputs at an output layer of the multi-model neural network to obtain estimated nonlinear interference. A result of the filtering/extracting may be an estimated interference (estimated nonlinear interference, estimated interference signal), which may be subtracted from the received victim signal (i.e., the signal subject to interference by the aggressor signal) to produce a mathematical representation of the intended receive signal.

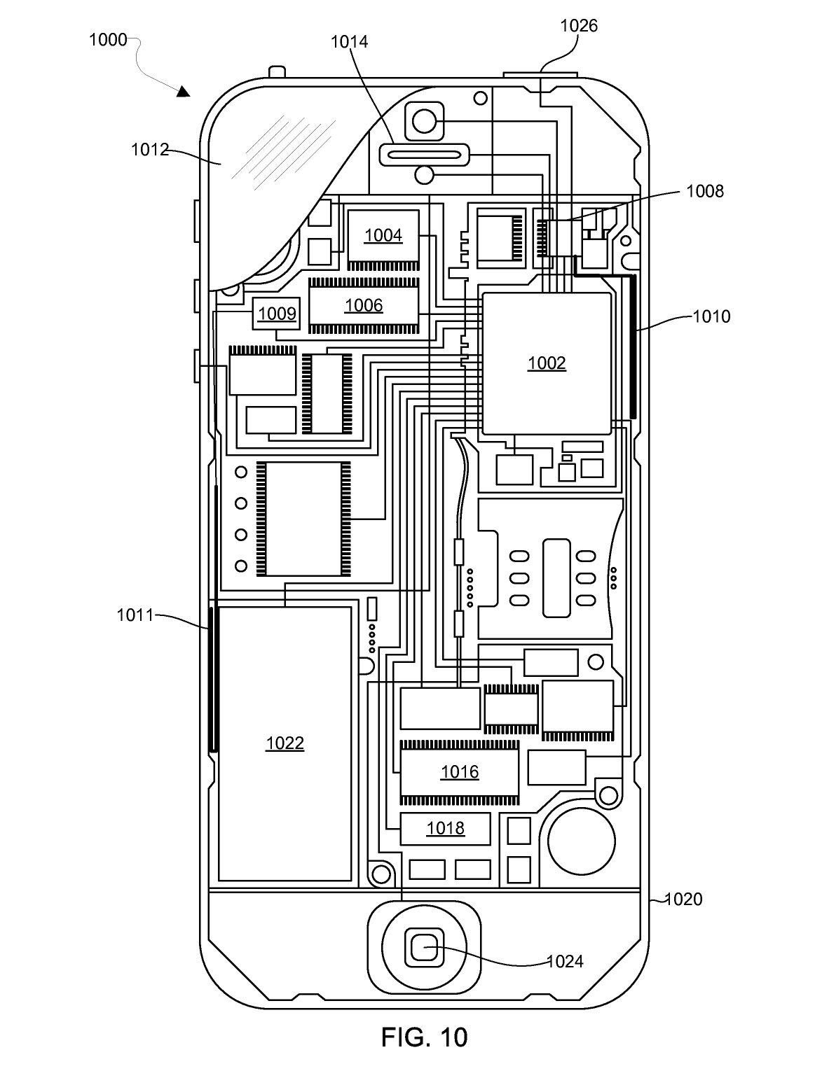

FIG. 10 illustrates an exemplary multi-technology communication device 1000 suitable for use with the various embodiments. The multi-technology communication device 1000 may be similar to the multi-technology device 110, 120, 200 (e.g., FIGS. 1 and 2). With reference to FIGS. 1-10, the multi-technology communication device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the multi-technology communication device 1000 need not have touch screen capability.

The multi-technology communication device 1000 may have two or more cellular network transceivers 1008, 1009 coupled to antennae 1010, 1011, for sending and receiving communications via a cellular communication network. The combination of the transceiver 1008 or 1009 and the associated antenna 1010 or 1011, and associated components, is referred to herein as a radio frequency (RF) chain. The cellular network transceivers 1008, 1009 may be coupled to the processor 1002, which is configured with processor-executable instructions to perform operations of the embodiment methods described above. The cellular network transceivers 1008, 1009 and antennae 1010, 1011 may be used with the above-mentioned circuitry to implement the various wireless transmission protocol stacks and interfaces. The multi-technology communication device 1000 may include one or more cellular network wireless modem chips 1016 coupled to the processor and the cellular network transceivers 1008, 1009 and configured to enable communication via cellular communication networks.

The multi-technology communication device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The multi-technology communication device 1000 may also include speakers 1014 for providing audio outputs. The multi-technology communication device 1000 may also include a housing 1020, constructed of a plastic, metal, or a combination of materials, for containing all or some of the components discussed herein. The multi-technology communication device 1000 may include a power source 1022 coupled to the processor 1002, such as a disposable or rechargeable battery. The rechargeable battery may also be coupled to the peripheral device connection port to receive a charging current from a source external to the multi-technology communication device 1000. The multi-technology communication device 1000 may also include a physical button 1024 for receiving user inputs. The multi-technology communication device 1000 may also include a power button 1026 for turning the multi-technology communication device 1000 on and off.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, s, circuits, and algorithm operations described in connection with the embodiments disclosed herein may be implemented as electronic hardware, computer software, or combinations of both. To clearly illustrate this interchangeability of hardware and software, various illustrative components, blocks, s, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, and circuits described in connection with the various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method for managing signal interference in a multi-technology communication device, comprising:
receiving an aggressor signal at an input layer of a multi-model neural network;
generating block least squares kernels (BLS kernels) and radial basis function kernels (RBF kernels);
executing a nonlinear radial basis function on the RBF kernels at a hidden layer of the multi-model neural network to produce hidden layer outputs;
augmenting the hidden layer outputs and the BLS kernels with weight factors at an intermediate layer of the multi-model neural network to produce augmented hidden layer outputs;
linearly combining the augmented hidden layer outputs and the BLS kernels at the intermediate layer to produce real intermediate layer outputs, and imaginary intermediate layer outputs; and
executing a linear filter function on the real intermediate layer outputs and the imaginary intermediate layer outputs at an output layer of the multi-model neural network to obtain an estimated nonlinear interference.

2. The method of claim 1, further comprising:
determining an error of the estimated nonlinear interference;
determining whether the error of the estimated nonlinear interference exceeds an efficiency threshold; and
canceling the estimated nonlinear interference from a victim signal.

3. The method of claim 2, further comprising training the weight factors to reduce the error of the estimated nonlinear interference.

4. The method of claim 3, wherein:
training the weight factors to reduce the error of the estimated nonlinear interference comprises training weight factors in response to determining that the error of the estimated nonlinear interference exceeds the efficiency threshold, and
canceling the estimated nonlinear interference from the victim signal comprises canceling the estimated nonlinear interference from the victim signal in response to determining that the error of the estimated nonlinear interference does not exceed the efficiency threshold.

5. The method of claim 3, further comprising training the weight factors using a least squares method.

6. The method of claim 1, wherein the linear filter function is a finite impulse response filter.

7. The method of claim 1, wherein the linear filter function has a Hammerstein structure.

8. The method of claim 1, wherein the received aggressor signal represents the aggressor signal received by an antenna of the multi-technology communication device at a specific instance in time.

9. The method of claim 1, wherein generating the BLS kernels and the RBF kernels comprises:
executing a first kernel function on the aggressor signal to obtain the BLS kernels;
separating the BLS kernels into real BLS aggressor kernels and imaginary BLS aggressor kernels;
executing a second kernel function on the aggressor signal to obtain the RBF kernels; and
separating the RBF kernels into real RBF components and imaginary RBF components.

10. The method of claim 9, further comprising:
continuing to execute the first kernel function of an order from 1 to “p”;
inserting the real BLS aggressor kernels associated with the order from 1 to “p” into a real BLS kernel matrix;
inserting the imaginary BLS aggressor kernels associated with the order from 1 to “p” into an imaginary BLS kernel matrix; and
inserting the real BLS kernel matrix and the imaginary BLS kernel matrix into a combined aggressor kernel matrix.

11. The method of claim 10, further estimating an initial value of the weight factors using the combined aggressor kernel matrix.

12. The method of claim 10, wherein inserting the real BLS kernel matrix and the imaginary BLS kernel matrix into the combined aggressor kernel matrix further comprises inserting the hidden layer outputs into the combined aggressor kernel matrix.

13. The method of claim 12, wherein the weight factors are calculated using the combined aggressor kernel matrix.

14. The method of claim 1, further comprising canceling the estimated nonlinear interference from a victim signal.

15. The method of claim 14, further comprising decoding the victim signal after canceling the estimated nonlinear interference from the victim signal.

16. The method of claim 1, further comprising training a second set of weight factors associated with the linear filter function using a matrix including the real intermediate layer output and the imaginary intermediate layer output.

17. The method of claim 16, wherein the second set of weight factors is trained using a least squares method.

18. The method of claim 1, wherein the estimated nonlinear interference comprises an RBF estimated interference and a BLS estimated interference.

19. The method of claim 18, further comprising:
augmenting the RBF estimated interference and the BLS estimated interference with a third set of weight factors at the output layer of the multi-model neural network; and
linearly combining the augmented RBF estimated interference and the augmented BLS estimated interference at the output layer to produce an estimated non-linear interference.

20. A multi-technology communication device, comprising:
an antenna; and
a processor communicatively connected to the antenna and configured with processor-executable instructions to perform operations comprising:
receiving an aggressor signal at an input layer of a multi-model neural network;
generating block least squares kernels (BLS kernels) and radial basis function kernels (RBF kernels);
executing a nonlinear radial basis function on the RBF kernels at a hidden layer of the multi-model neural network to produce hidden layer outputs;
augmenting the hidden layer outputs and the BLS kernels with weight factors at an intermediate layer of the multi-model neural network to produce augmented hidden layer outputs;
linearly combining the augmented hidden layer outputs and the BLS kernels at the intermediate layer to produce real intermediate layer outputs, and imaginary intermediate layer outputs; and
executing a linear filter function on the real intermediate layer outputs and the imaginary intermediate layer outputs at an output layer of the multi-model neural network to obtain an estimated nonlinear interference.

21. The multi-technology communication device of claim 20, wherein the processor is configured with processor-executable instructions to perform operations further comprising:
executing a first kernel function on the aggressor signal to obtain the BLS kernels;
separating the BLS kernels into real BLS aggressor kernels and imaginary BLS aggressor kernels;
executing a second kernel function on the aggressor signal to obtain the RBF kernels; and
separating the RBF kernels into real RBF components and imaginary RBF components.

22. The multi-technology communication device of claim 21, wherein the processor is configured with processor-executable instructions to perform operations further comprising:
continuing to execute the first kernel function of an order from 1 to “p”;
inserting the real BLS aggressor kernels associated with the order from 1 to “p” into a real BLS kernel matrix;
inserting the imaginary BLS aggressor kernels associated with the order from 1 to “p” into an imaginary BLS kernel matrix; and
inserting the real BLS kernel matrix and the imaginary BLS kernel matrix into a combined aggressor kernel matrix.

23. The multi-technology communication device of claim 22, wherein the processor is configured with processor-executable instructions to perform operations such that inserting the real BLS kernel matrix and the imaginary BLS kernel matrix into the combined aggressor kernel matrix further comprises inserting the hidden layer outputs into the combined aggressor kernel matrix.

24. The multi-technology communication device of claim 22, wherein the processor is configured with processor-executable instructions to perform operations such that the weight factors are calculated using the combined aggressor kernel matrix.

25. The multi-technology communication device of claim 24, wherein the processor is configured with processor-executable instructions to perform operations further comprising canceling the estimated nonlinear interference from a victim signal received by the antenna.

26. The multi-technology communication device of claim 25, wherein the processor is configured with processor-executable instructions to perform operations further comprising decoding the victim signal after canceling the estimated nonlinear interference from the victim signal.

27. The multi-technology communication device of claim 20, wherein the estimated nonlinear interference comprises an RBF estimated interference and a BLS estimated interference.

28. The multi-technology communication device of claim 27, wherein the processor is configured with processor-executable instructions to perform operations further comprising:
augmenting the RBF estimated interference and the BLS estimated interference with a third set of weight factors at the output layer of the multi-model neural network; and
linearly combining the augmented RBF estimated interference and the BLS estimated interference at the output layer to produce an estimated non-linear interference.

29. A computing device comprising:
means for receiving an aggressor signal at an input layer of a multi-model neural network;
means for generating block least squares kernels (BLS kernels) and radial basis function kernels (RBF kernels);
means for executing a nonlinear radial basis function on the RBF kernels at a hidden layer of the multi-model neural network to produce hidden layer outputs;
means for augmenting the hidden layer outputs and the BLS kernels with weight factors at an intermediate layer of the multi-model neural network to produce augmented hidden layer outputs;
means for linearly combining the augmented hidden layer outputs and the BLS kernels at the intermediate layer to produce real intermediate layer outputs, and imaginary intermediate layer outputs; and
means for executing a linear filter function on the real intermediate layer outputs and the imaginary intermediate layer outputs at an output layer of the multi-model neural network to obtain estimated nonlinear interference.

30. A non-transitory processor-readable medium having stored thereon processor-executable software instructions to cause a processor of a multi-technology communication device to perform operations comprising:
receiving an aggressor signal at an input layer of a multi-model neural network;
generating block least squares kernels (BLS kernels) and radial basis function kernels (RBF kernels);
executing a nonlinear radial basis function on the RBF kernels at a hidden layer of the multi-model neural network to produce hidden layer outputs;
augmenting the hidden layer outputs and the BLS kernels with weight factors at an intermediate layer of the multi-model neural network to produce augmented hidden layer outputs;
linearly combining the augmented hidden layer outputs and the BLS kernels at the intermediate layer to produce real intermediate layer outputs, and imaginary intermediate layer outputs; and
executing a linear filter function on the real intermediate layer outputs and the imaginary intermediate layer outputs at an output layer of the multi-model neural network to obtain estimated nonlinear interference.
